(19) United States
(12) Patent Application Publication
(10) Pub. No.: US 2013/0329797 A1
(43) Pub. Date: Dec. 12, 2013

(54) IMAGE CODING METHOD AND IMAGE DECODING METHOD

(71) Applicants: Toshiyasu Sugio, Osaka (JP); Takahiro Nishi, Nara (JP); Youji Shibahara, Osaka (JP); Hisao Sasai, Osaka (JP)

(72) Inventors: Toshiyasu Sugio, Osaka (JP); Takahiro Nishi, Nara (JP); Youji Shibahara, Osaka (JP); Hisao Sasai, Osaka (JP)

(73) Assignee: PANASONIC CORPORATION, Osaka (JP)

(21) Appl. No.: 14/000,476

(22) PCT Filed: Feb. 20, 2012
(86) PCT No.: PCT/JP2012/001107

§ 371 Date: Aug. 20, 2013

Related U.S. Application Data
(60) Provisional application No. 61/446,671, filed on Feb. 25, 2011.

(51) Int. Cl. H04N 7/36

(52) U.S. Cl. CPC H04N 19/00721
USPC 375/240.15; 375/240.16

(57) ABSTRACT

An image coding method includes: writing, to a memory, a first motion vector for a first sub-block; reading, from the memory, the first motion vector; coding a second motion vector for a second sub-block, using the first motion vector; selecting a representative motion vector from among motion vectors for sub-blocks; determining whether or not the representative motion vector is used in place of the first motion vector; and adding, to a bitstream, a flag indicating whether or not the representative motion vector is used, wherein when the representative motion vector is used: in the writing, the representative motion vector is written to the memory; in the reading, the representative motion vector is read from the memory; and in the coding, the second motion vector is coded using the representative motion vector.

### TECHNICAL FIELD

The present invention relates to an image coding method for coding an image and an image decoding method for decoding an image.

### BACKGROUND ART

In moving picture coding processes, an information amount is typically compressed using redundancy of moving pictures in spatial and temporal directions. Here, transformation into a frequency domain is typically used as a compression method using redundancy in the spatial direction, and inter-picture prediction (hereinafter referred to as “inter prediction”) is used as a compression method using redundancy in the temporal direction. In coding a certain picture, a coded picture that precedes or follows the current picture to be coded in display time order is used as a reference picture in the inter prediction coding. Then, a motion vector is derived by motion estimation of the current picture with reference to the reference picture. The redundancy in the temporal direction is removed by obtaining a difference between predicted image data obtained through motion compensation based on the motion vector and image data of the current picture. Here, in the motion estimation, a difference value between the current block to be coded within the current picture and each of blocks in the reference picture is calculated, and the block in the reference picture having the smallest difference value is determined to be a reference block. Then, the motion vector is estimated using the current block and the reference block.

The moving picture coding scheme called H.264 which has already been standardized uses three types of pictures, that is, I-picture, P-picture, and B-picture to compress the information amount. The I-picture is a picture on which the inter prediction coding is not performed, that is, prediction coding within a picture (hereinafter referred to as “intra prediction”) is performed. The P-picture is a picture on which the inter prediction coding is performed with reference to one coded picture preceding or following the current picture in display time order. The B-picture is a picture on which the inter prediction coding is performed with reference to two coded pictures preceding or following the current picture in display time order.

Furthermore, the moving picture coding scheme called H.264 has a motion vector estimation mode as a coding mode for each current block to be coded in a B-picture. In the motion vector estimation mode, a difference value between predicted image data and image data of the current block, and a motion vector for generating the predicted image data are coded. Furthermore, in the motion vector estimation mode, one of (i) bi-directional prediction for generating a predicted image with reference to two coded pictures that precede or follow the current picture and (ii) unidirectional prediction for generating a predicted image with reference to one coded picture that precedes or follows the current picture can be selected as a prediction direction.

Furthermore, in the moving picture coding scheme called H.264, when a motion vector is derived in coding a B-picture, a coding mode called a temporal motion vector predictor mode can be selected. The inter prediction coding method in the temporal motion vector predictor mode will be described with reference to FIG. 37. FIG. 37 illustrates motion vectors in the temporal motion vector predictor mode, and a case where a block “a” of a picture B2 is coded in the temporal motion vector predictor mode. Here, a motion vector vb is used. The motion vector vb is used in coding a block “b” that is located in the same position as that of the block “a” and is within a picture P3 that is a reference picture behind the picture B2. Furthermore, the motion vector vb is a motion vector used when the block “b” is coded, and references a picture P1. The block “a” obtains a reference block from each of the picture P1 that is a forward reference picture and the picture P3 that is a backward reference picture, using a motion vector parallel to the motion vector vb, and is coded in the bi-directional prediction. In other words, the motion vector used in coding the block “a” is a motion vector va1 for the picture P1, and is a motion vector vat for the picture P3.

### CITATION LIST

### Non Patent Literature

[NPL 1] ITU-T Recommendation H.264, “Advanced video coding for generic audiovisual services”, March 2010

### SUMMARY OF INVENTION

### Technical Problem

In the conventional temporal motion vector predictor mode, however, a motion vector used in calculating a temporal motion vector predictor needs to be pre-stored in a memory. For example, when all the current blocks to be coded in the reference picture P3 in FIG. 37 are bi-directional prediction blocks, each of the current blocks has at least two motion vectors. Thus, in order to store all the motion vectors for the reference pictures in calculating a temporal motion vector predictor, a large amount of memory is required, and the memory bandwidth increases.

Here, the present invention has an object of providing an image coding method in which the necessary memory and the bandwidth in the temporal motion vector predictor mode can be reduced.

### Solution to Problem

In order to solve the problems, the image coding method according to an aspect of the present invention is an image coding method for coding an image, the method including: writing, to a memory, a first motion vector for a first sub-block included in a first block in a first picture; reading, from the memory, the first motion vector written to the memory; coding a second motion vector for a second sub-block included in a second block, using the first motion vector read from the memory, the second block being a block in a second picture different from the first picture and being located in a position corresponding to a position of the first block; selecting a representative motion vector from among motion vectors for sub-blocks included in the first block; determining whether or not the representative motion vector is used in place of the first motion vector; and adding, to a bitstream, a flag indicating whether or not the representative motion vector is used, wherein when the representative motion vector is used: in the writing, the representative motion vector is written to the memory in place of the first motion vector; in the reading, the representative motion vector is read from the memory in place of the first motion vector; and in the coding, the second motion vector is coded using the representative motion vector in place of the first motion vector.

The image coding method may further include scaling the representative motion vector, using a display order of a reference picture to be referenced by the representative motion vector and a display order of a reference picture to be referenced by the first motion vector, wherein when the representative motion vector is used, in the coding, the second motion vector may be coded using the scaled representative motion vector.

Furthermore, in the selecting of a representative motion vector, one of the motion vectors that is to be used in bi-directional prediction may be preferentially selected as the representative motion vector.

Furthermore, in the selecting of a representative motion vector, the representative motion vector may be selected from among the motion vectors for the sub-blocks to which inter prediction is to be applied.

Furthermore, in the selecting of a representative motion vector, the representative motion vector may be selected by searching the motion vectors for the representative motion vector in a predetermined order.

Furthermore, the predetermined order may be one of a raster order and a zigzag scan order, from an upper left position to a lower right position in the first block, and in the selecting of a representative motion vector, the representative motion vector may be selected by searching for the representative motion vector in one of the raster order and the zigzag scan order.

Furthermore, the predetermined order may be an order from a periphery to a center of the first block, and in the selecting of a representative motion vector, the representative motion vector may be selected by searching for the representative motion vector in the order from the periphery to the center of the first block.

Furthermore, in the selecting of a representative motion vector, when a representative sub-block that is a sub-block having the representative motion vector has two or more motion vectors, the two or more motion vectors may be selected as a plurality of the representative motion vectors, the image coding method may further include selecting one of the two or more motion vectors, based on whether or not the first picture precedes or follows the second picture in display order, and when the representative motion vector is used, in the coding, the second motion vector may be coded using the selected one of two or more motion vectors.

Furthermore, in the selecting of one of the two or more motion vectors: when (i) the two or more motion vectors include a motion vector that references a picture that precedes the first picture and a motion vector that references a picture that follows the first picture and (ii) the first picture precedes the second picture, the motion vector that references the picture that precedes the first picture may be selected from among the two or more motion vectors; and when (i) the two or more motion vectors include the motion vector that references the picture that precedes the first picture and the motion vector that references the picture that follows the first picture and (ii) the first picture follows the second picture, the motion vector that references the picture that follows the first picture may be selected from among the two or more motion vectors.

Furthermore, in the selecting of one of the two or more motion vectors: when (i) one of the two or more motion vectors references a picture that precedes the first picture and (ii) an other one of the two or more motion vectors references a picture that follows the first picture, one of the two or more motion vectors may be selected based on whether the first picture precedes or follows the second picture in display order, and when all of the two or more motion vectors reference a picture that precedes the first picture or reference a picture that follows the first picture, one of the two or more motion vectors may be selected irrespective of whether the first picture precedes or follows the second picture in display order.

Furthermore, the image decoding method according to an aspect of the present invention may be an image decoding method for decoding an image, the method including: writing, to a memory, a first motion vector for a first sub-block included in a first block in a first picture; reading, from the memory, the first motion vector written to the memory; decoding a second motion vector for a second sub-block included in a second block, using the first motion vector read from the memory, the second block being a block in a second picture different from the first picture and being located in a position corresponding to a position of the first block; selecting a representative motion vector from among motion vectors for sub-blocks included in the first block; and obtaining a flag indicating whether or not the representative motion vector is used, from a bitstream, wherein when the representative motion vector is used: in the writing, the representative motion vector may be written to the memory in place of the first motion vector; in the reading, the representative motion vector may be read from the memory in place of the first motion vector; and in the decoding, the second motion vector may be decoded using the representative motion vector in place of the first motion vector.

Furthermore, the image decoding method may further include scaling the representative motion vector, using a display order of a reference picture to be referenced by the representative motion vector and a display order of a reference picture to be referenced by the first motion vector, wherein when the representative motion vector is used, in the decoding, the second motion vector may be decoded using the scaled representative motion vector.

Furthermore, in the selecting of a representative motion vector, one of the motion vectors that is to be used in bi-directional prediction may be preferentially selected as the representative motion vector.

Furthermore, in the selecting of a representative motion vector, the representative motion vector may be selected from among the motion vectors for the sub-blocks to which inter prediction is to be applied.

Furthermore, in the selecting of a representative motion vector, the representative motion vector may be selected by searching the motion vectors for the representative motion vector in a predetermined order.

Furthermore, the predetermined order may be one of a raster order and a zigzag scan order, from an upper left position to a lower right position in the first block, and in the selecting of a representative motion vector, the representative motion vector may be selected by searching for the representative motion vector in one of the raster order and the zigzag scan order.

Furthermore, the predetermined order may be an order from a periphery to a center of the first block, and in the selecting of a representative motion vector, the representative motion vector may be selected by searching for the representative motion vector in the order from the periphery to the center of the first block.

Furthermore, in the selecting of a representative motion vector, when a representative sub-block that is a sub-block having the representative motion vector has two or more motion vectors, the two or more motion vectors may be selected as a plurality of the representative motion vectors, the image decoding method may further include selecting one of the two or more motion vectors, based on whether or not the first picture precedes or follows the second picture in display order, and when the representative motion vector is used, in the decoding, the second motion vector may be decoded using the selected one of two or more motion vectors.

Furthermore, in the selecting of one of the two or more motion vectors: when (i) the two or more motion vectors include a motion vector that references a picture that precedes the first picture and a motion vector that references a picture that follows the first picture and (ii) the first picture precedes the second picture, the motion vector that references the picture that precedes the first picture may be selected from among the two or more motion vectors; and when (i) the two or more motion vectors include the motion vector that references the picture that precedes the first picture and the motion vector that references the picture that follows the first picture and (ii) the first picture follows the second picture, the motion vector that references the picture that follows the first picture may be selected from among the two or more motion vectors.

Furthermore, in the selecting of one of the two or more motion vectors: when (i) one of the two or more motion vectors references a picture that precedes the first picture and (ii) an other one of the two or more motion vectors references a picture that follows the first picture, one of the two or more motion vectors may be selected based on whether the first picture precedes or follows the second picture in display order, and when all of the two or more motion vectors reference a picture that precedes the first picture or reference a picture that follows the first picture, one of the two or more motion vectors may be selected irrespective of whether the first picture precedes or follows the second picture in display order.

### Advantageous Effects of Invention

According to the present invention, a new criterion for appropriately controlling motion vector information to be held in a memory in the temporal motion vector predictor mode is used. Accordingly, the necessary memory capacity and bandwidth in the temporal motion vector predictor mode can be reduced.

### BRIEF DESCRIPTION OF DRAWINGS

FIG. 1 is a block diagram illustrating a configuration of an image coding apparatus according to Embodiment 1.

FIG. 2 is a flowchart indicating operations performed by the image coding apparatus according to Embodiment 1.

FIG. 3 illustrates candidate predicted motion vectors according to Embodiment 1.

FIG. 4 is a table showing codes of motion vector predictor indexes according to Embodiment 1.

FIG. 5 is a flowchart of processes for selecting a motion vector predictor according to Embodiment 1.

FIG. 6 schematically illustrates a process for reading and writing colPic information according to Embodiment 1.

FIG. 7 illustrates details of the process for reading and writing colPic information according to Embodiment 1.

FIG. 8 is a flowchart of processes for determining co-located information according to Embodiment 1.

FIG. 9 is a flowchart of processes for adding a temporal motion vector predictor according to Embodiment 1.

FIG. 10 is a flowchart of processes for calculating a temporal motion vector predictor according to Embodiment 1.

FIG. 11A illustrates a first example for calculating a temporal motion vector predictor according to Embodiment 1.

FIG. 11B illustrates a second example for calculating a temporal motion vector predictor according to Embodiment 1.

FIG. 12A illustrates a third example for calculating a temporal motion vector predictor according to Embodiment 1.

FIG. 12B illustrates a fourth example for calculating a temporal motion vector predictor according to Embodiment 1.

FIG. 13 is a flowchart of processes for transferring colPic information according to Embodiment 1.

FIG. 14 is a flowchart of detailed processes for transferring colPic information according to Embodiment 1.

FIG. 15A illustrates a first example of a searching order according to Embodiment 1.

FIG. 15B illustrates a second example of a searching order according to Embodiment 1.

FIG. 16 is a block diagram illustrating a configuration of an image decoding apparatus according to Embodiment 2.

FIG. 17 is a flowchart indicating operations performed by the image decoding apparatus according to Embodiment 2.

FIG. 18 illustrates an overall configuration of a content providing system for implementing content distribution services.

FIG. 19 illustrates an overall configuration of a digital broadcasting system.

FIG. 20 illustrates a block diagram illustrating an example of a configuration of a television.

FIG. 21 illustrates a block diagram illustrating an example of a configuration of an information reproducing/recording unit that reads and writes information from or on a recording medium that is an optical disc.

FIG. 22 illustrates an example of a configuration of a recording medium that is an optical disc.

FIG. 23A illustrates an example of a cellular phone.

FIG. 23B illustrates an example of a configuration of the cellular phone.

FIG. 24 illustrates a structure of the multiplexed data.

FIG. 25 schematically illustrates how each stream is multiplexed in the multiplexed data.

FIG. 26 illustrates how a video stream is stored in a stream of PES packets in more detail.

FIG. 27 illustrates a structure of TS packets and source packets in the multiplexed data.

FIG. 28 illustrates a data structure of a PMT.

FIG. 29 illustrates an internal structure of multiplexed data information.

FIG. 30 illustrates an internal structure of stream attribute information.

FIG. 31 illustrates steps for identifying video data.

FIG. 32 illustrates a block diagram illustrating an example of a configuration of an integrated circuit for implementing a moving picture coding method and a moving picture decoding method according to each of Embodiments.

FIG. 33 illustrates a configuration for switching between driving frequencies.

FIG. 34 illustrates steps for identifying video data and switching between driving frequencies.

FIG. 35 illustrates an example of a look-up table in which the standards of video data are associated with the driving frequencies.

FIG. 36A illustrates an example of a configuration for sharing a module of a signal processing unit.

FIG. 36B illustrates another example of a configuration for sharing a module of a signal processing unit.

FIG. 37 illustrates a conventional temporal motion vector predictor mode.

### DESCRIPTION OF EMBODIMENTS

Embodiments according to the present invention will be described with reference to the drawings. Embodiments to be described hereinafter indicate specific and preferable examples of the present invention. The values, shapes, materials, constituent elements, positions and connections of the constituent elements, steps, and orders of the steps indicated in Embodiments are examples, and do not limit the present invention. The present invention is specified only by the claims. Furthermore, the constituent elements in Embodiments that are not described in independent claims that describe the most generic concept of the present invention are described as arbitrary constituent elements for composing more preferable embodiments.

### Embodiment 1

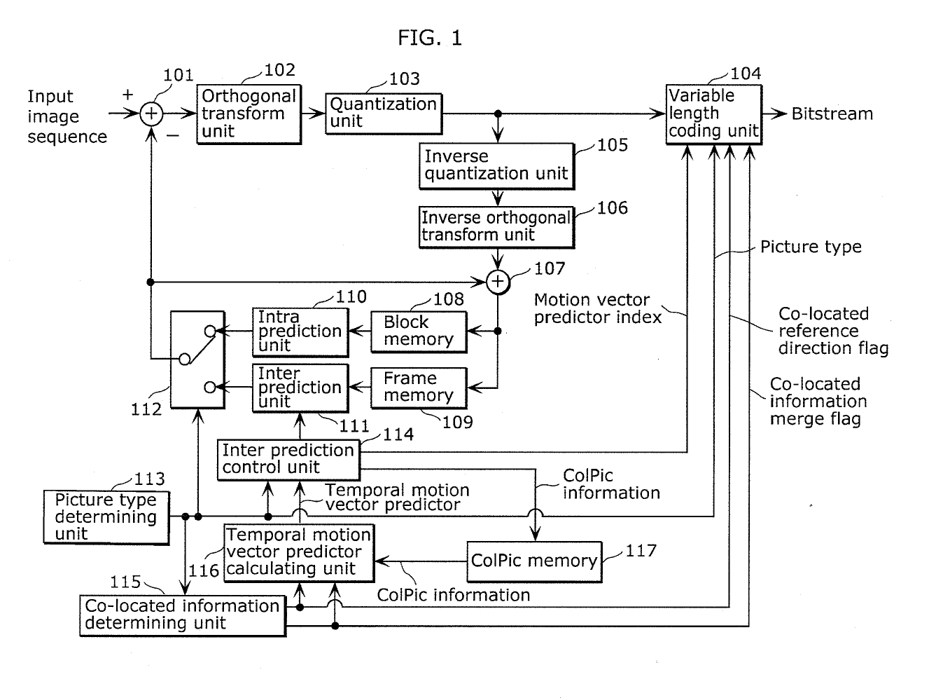

FIG. 1 is a block diagram illustrating a configuration of an image coding apparatus according to Embodiment 1.

As illustrated in FIG. 1, the image coding apparatus includes a subtracting unit 101, an orthogonal transform unit 102, a quantization unit 103, an inverse quantization unit 105, an inverse orthogonal transform unit 106, an adding unit 107, a block memory 108, a frame memory 109, an intra prediction unit 110, an inter prediction unit 111, a switch unit 112, an inter prediction control unit 114, a picture type determining unit 113, a temporal motion vector predictor calculating unit 116, a colPic memory 117, a co-located information determining unit 115, and a variable length coding unit 104.

The orthogonal transform unit 102 transforms an input image sequence from an image domain to a frequency domain. The quantization unit 103 quantizes the input image sequence transformed to the frequency domain. The inverse quantization unit 105 inversely quantizes the input image sequence quantized by the quantization unit 103. The inverse orthogonal transform unit 106 transforms the input image sequence inversely quantized, from the frequency domain to the image domain.

The block memory 108 is a memory for storing the input image sequence per block. The frame memory 109 is a memory for storing the input image sequence per frame. The picture type determining unit 113 determines in which picture type the input image sequence is coded, either I-picture, B-picture, or P-picture, and generates picture type information.

The intra prediction unit 110 performs intra-prediction coding on the current block using the input image sequence stored per block in the block memory 108 to generate predicted image data. The inter prediction unit 111 performs inter-prediction coding on the current block using (i) the input image stored per frame in the frame memory 109 and (ii) a motion vector derived from the motion estimation to generate predicted image data.

The co-located information determining unit 115 (i) determines, as a co-located block, one of a block included in a picture preceding the current picture in display time order (hereinafter referred to as “forward reference block”) and a block included in a picture following the current picture in display time order (hereinafter referred to as “backward reference block”), (ii) generates a co-located reference direction flag for each picture, and (iii) attaches the generated co-located reference direction flag to the current picture.

Furthermore, the co-located information determining unit 115 determines whether or not only a representative motion vector selected as a representative from among motion vectors for the co-located block is to be stored in the colPic memory 117. Then, the co-located information determining unit 115 generates a co-located information merge flag indicating a result of the determination, per picture, and attaches the flag to the current picture.

Here, the co-located block is a block in a picture different from the picture including the current block, and is a block located in a position corresponding to a position of the current block in the picture.

The temporal motion vector predictor calculating unit 116 derives motion vector predictor candidates (temporal motion vector predictors) in the temporal motion vector predictor mode, using the colPic information for the motion vectors for the co-located block that are stored in the colPic memory 117. Furthermore, the temporal motion vector predictor calculating unit 116 allocates a value of a motion vector predictor index corresponding to each of the temporal motion vector predictors.

Furthermore, the temporal motion vector predictor calculating unit 116 transmits, to the inter prediction control unit 114, the temporal motion vector predictor and the motion vector predictor index. When the co-located block does not have any motion vector, the temporal motion vector predictor calculating unit 116 stops deriving a motion vector in the temporal motion vector predictor mode, or derives a motion vector predictor candidate (temporal motion vector predictor) by setting 0 to the motion vector.

The inter prediction control unit 114 determines to code a motion vector, using one of motion vector predictor candidates having the smallest difference with the motion vector derived from the motion estimation. Here, the difference is a difference value between the motion vector predictor candidate and the motion vector derived from the motion estimation.

Furthermore, the inter prediction control unit 114 generates a motion vector predictor index corresponding to the determined motion vector predictor, per block. Furthermore, the inter prediction control unit 114 transmits the motion vector predictor index and difference information on the motion vector predictor candidate, to the variable length coding unit 104. Furthermore, the inter prediction control unit 114 transfers the colPic information including the motion vector for the current block, to the colPic memory 117.

The colPic memory 117 stores motion vectors for reference pictures, index values of the reference pictures, and a prediction direction to calculate the temporal motion vector predictor for the current block. The number of motion vectors for the reference pictures to be stored in the colPic memory 117 is reduced in a method to be described later, when the co-located information merge flag is ON.

The orthogonal transform unit 102 transforms the generated predicted image data and prediction error data with respect to the input image sequence, from the image domain to the frequency domain. The quantization unit 103 quantizes the prediction error data transformed to the frequency domain.

The variable length coding unit 104 variable-length codes the quantized prediction error data, the motion vector predictor index, prediction error information on the motion vector predictor candidate, the picture type information, the co-located reference direction flag, and the co-located information merge flag. Accordingly, the variable length coding unit 104 generates the bitstream.

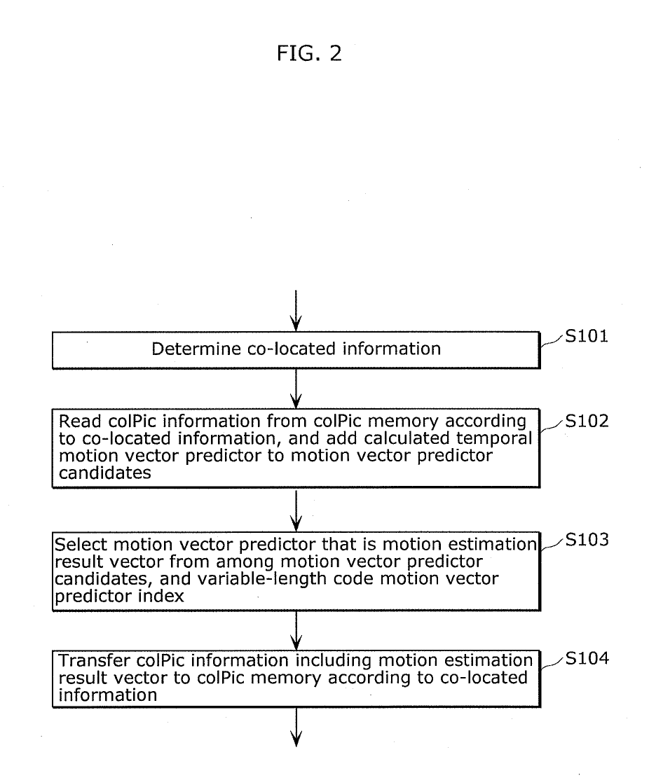

FIG. 2 shows an outline of processes of an image coding method according to Embodiment 1. First, the co-located information determining unit 115 determines co-located information, such as a co-located reference direction flag and a co-located information merge flag in a method to be described later, when deriving a motion vector predictor candidate in the temporal motion vector predictor mode (S101).

Next, the temporal motion vector predictor calculating unit 116 reads the colPic information including the reference motion vector for the co-located block, from the colPic memory 117 according to the co-located information. Then, the temporal motion vector predictor calculating unit 116 derives a motion vector predictor candidate (temporal motion vector predictor) in the temporal motion vector predictor mode, using the reference motion vector for the co-located block (S102).

Then, the temporal motion vector predictor calculating unit 116 allocates a value of a motion vector predictor index corresponding to the temporal motion vector predictor. Typically, the smaller the value of the motion vector predictor index is, the smaller the necessary information (code) amount is. On the other hand, the larger the value is, the larger the necessary information (code) amount is. Thus, the coding efficiency increases when the value of the motion vector predictor index corresponding to a motion vector that is highly likely to be a motion vector with higher precision is set smaller.

The inter prediction unit 111 performs inter-prediction coding on a picture using the motion vector derived from the motion estimation (S103). Furthermore, the variable length coding unit 104 codes the motion vector using one of the motion vector predictor candidates having the smallest difference.

For example, the inter prediction control unit 114 determines to use the motion vector predictor candidate having the smallest difference for coding the motion vector. Here, the difference is a difference value between the motion vector predictor candidate and the motion vector derived from the motion estimation. Then, the variable-length coding unit 104 performs variable-length coding on the motion vector predictor index corresponding to the selected motion vector predictor candidate and the difference information on the determined motion vector predictor candidate.

In a method to be described later, the inter prediction control unit 114 transfers the colPic information including the motion vector used in the inter prediction, to the colPic memory 117, and stores the colPic information in the colPic memory 117 (S104).

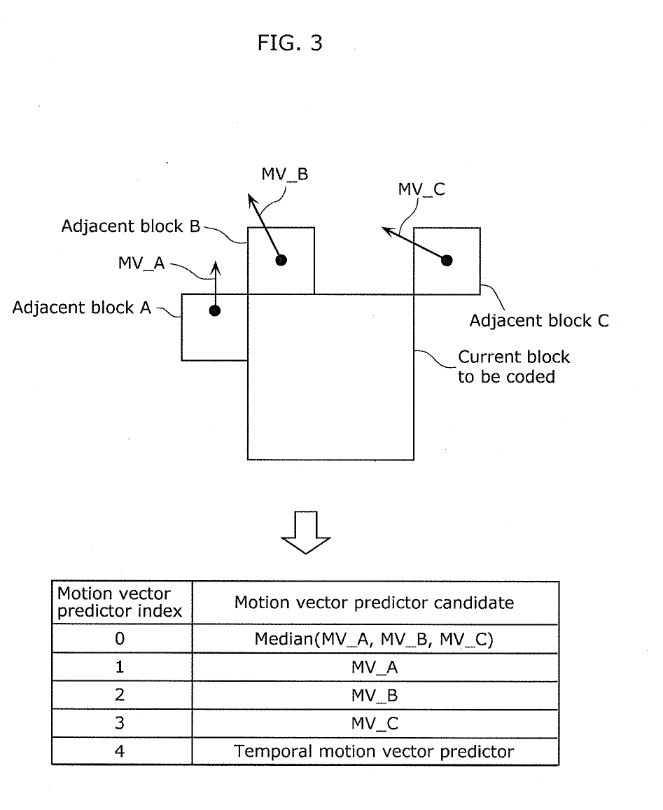

FIG. 3 illustrates an example of motion vector predictor candidates. A motion vector MV_A is a motion vector for an adjacent block A to the left of the current block. A motion vector MV_B is a motion vector for an adjacent block B above the current block. A motion vector MV_C is a motion vector for an adjacent block C to the upper right of the current block. Furthermore, Median (MV_A, MV_B, MV_C) indicates a median value of the motion vectors A, B, and C. Here, the median value is derived as indicated below.

$$\begin{matrix} [ Math 1 ] & \\ Median ( x , y , z ) = x + y + z - Min ( x , Min ( y , z ) ) - Max ( x , Max ( y , z ) ) & ( Equation 1 ) \\ [ Math 2 ] & \\ Min ( x , y ) = \{ \begin{matrix}x & ( x \leq y ) \\ y & ( x > y )\end{matrix} & ( Equation 2 ) \\ [ Math 3 ] & \\ Max ( x , y ) = \{ \begin{matrix}x & ( x \geq y ) \\ y & ( x < y )\end{matrix} & ( Equation 3 )\end{matrix}$$

The value of the motion vector predictor index corresponding to Median (MV_A, MV_B, MV_C) is 0, the value corresponding to the motion vector A is 1, the value corresponding to MV_B is 2, the value corresponding to MV_C is 3, and the value corresponding to the temporal motion vector predictor is 4. The method of allocating a motion vector predictor index is not limited to this example.

For example, when the co-located information merge flag is OFF, the number of reference motion vectors for the co-located block is not reduced. Thus, the temporal motion vector predictor calculated from the reference motion vectors for the co-located block probably have higher precision. Thus, when the co-located information merge flag is OFF, the coding efficiency can be increased by setting smaller an index value to be allocated to the temporal motion vector predictor than those of the other motion vector predictor candidates.

On the other hand, when the co-located information merge flag is ON, the coding efficiency can be increased by setting larger an index value to be allocated to the temporal motion vector predictor than those of the other motion vector predictor candidates.

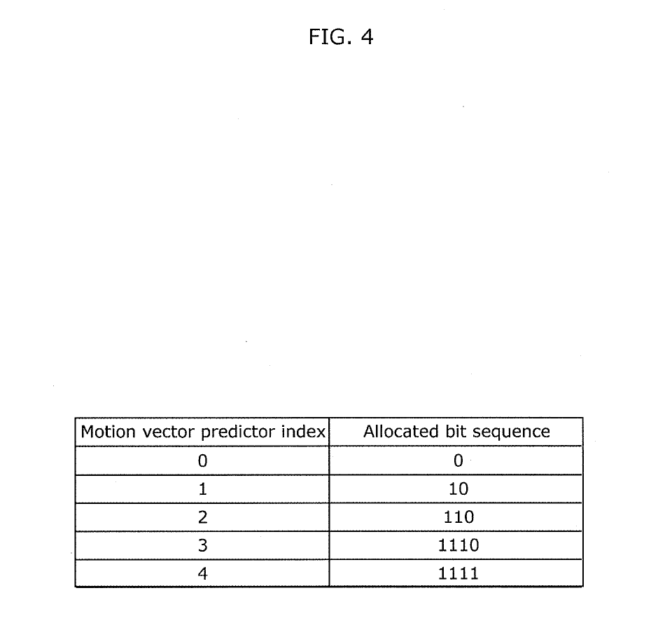

FIG. 4 is an example code table for variable-length coding motion vector predictor indexes. A code with a shorter code length is allocated to each of the motion vector predictor indexes in ascending order. Thus, the coding efficiency can be increased by setting smaller a value of the motion vector predictor index corresponding to the motion vector predictor candidate that probably has high prediction precision.

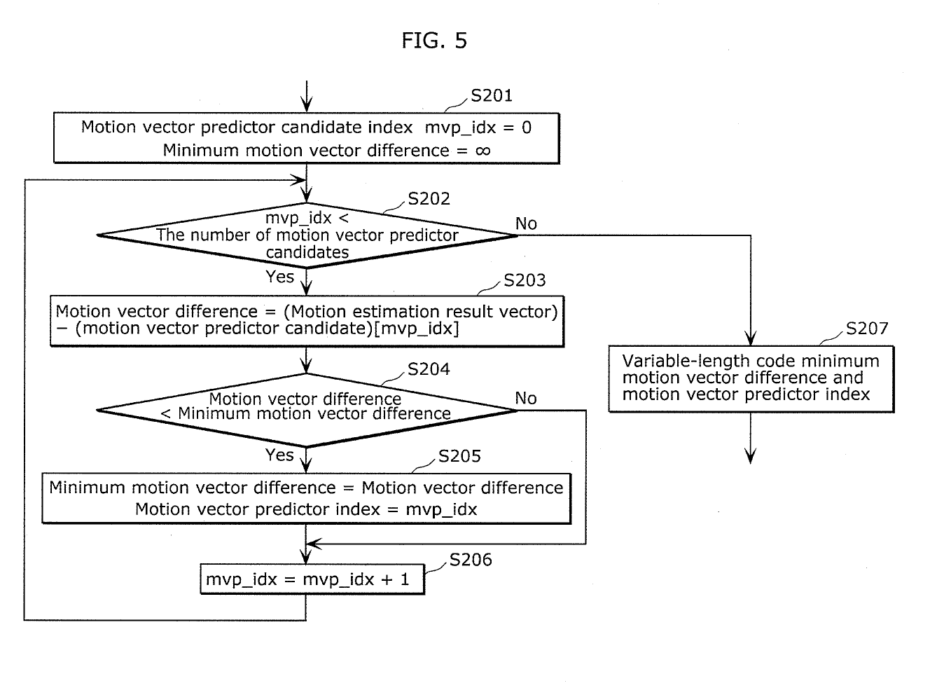

FIG. 5 is a flowchart indicating a procedure of the inter prediction control unit 114 for determining a motion vector predictor candidate. According to the procedure in FIG. 5, the inter prediction control unit 114 determines a motion vector predictor candidate having the smallest difference with the motion vector derived from the motion estimation to be used in coding the motion vector. Then, the variable length coding unit 104 variable-length codes the difference information on the determined motion vector predictor candidate and the motion vector predictor index indicating the determined motion vector predictor.

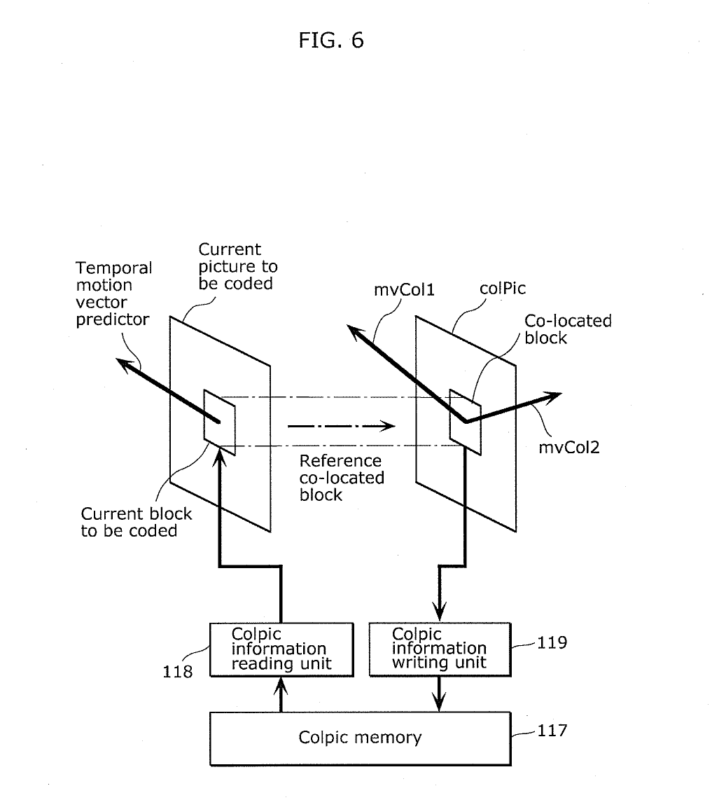

FIG. 6 schematically illustrates a process for reading and writing information from and to the colPic memory 117 in FIG. 1. In FIG. 6, a colPic information writing unit 119 stores, in the colPic memory 117, a motion vector mvCol1 in a prediction direction 1 and a motion vector mvCol2 in a prediction direction 2, for the co-located block in a co-located picture colPic according to the co-located information merge flag in a method to be described later.

Although Embodiment 1 describes the example in which the prediction direction 1 is for forward reference and the prediction direction 2 is for backward reference, the prediction direction 1 may be for backward reference and the prediction direction 2 may be for forward reference, or both of the prediction directions 1 and 2 may be for one of the forward reference and the backward reference.

Furthermore, the co-located block is a block that is located in a position of the co-located picture colPic and corresponds to a position of the current block in the current picture. The co-located reference direction flag can switch whether the co-located picture colPic follows or precedes the current picture.

Then, when the current block is coded, a colPic information reading unit 118 reads the colPic information including the motion vector stored in the colPic memory 117, according to the co-located information merge flag in a method to be described later. Then, the temporal motion vector predictor calculating unit 116 calculates the temporal motion vector predictor. The calculated temporal motion vector predictor is used for coding the current block.

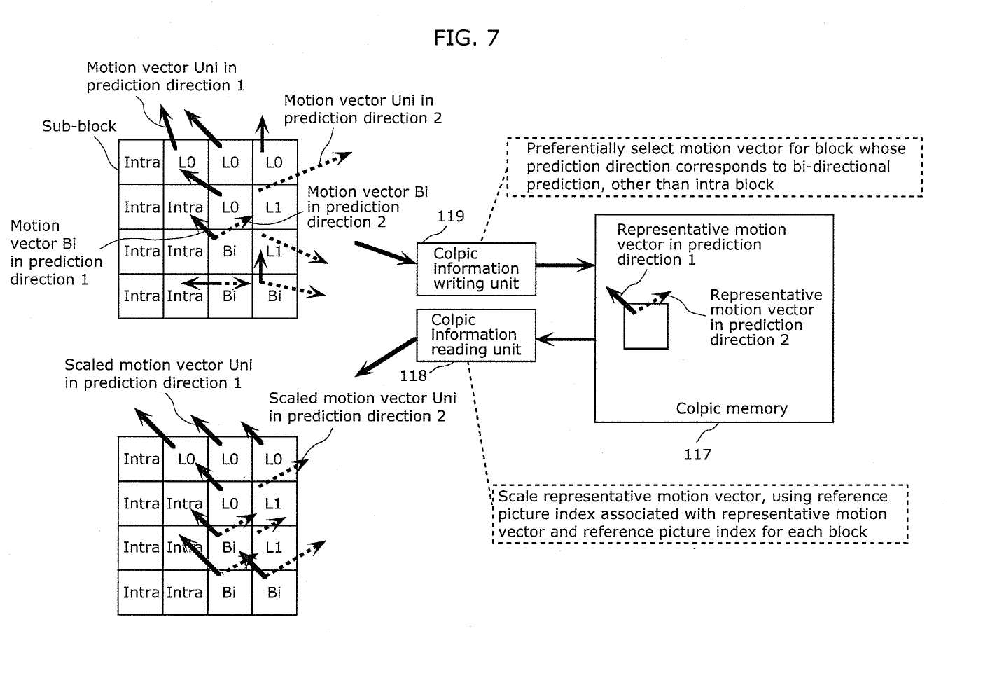

FIG. 7 illustrates an example of the process for reading and writing a motion vector from and to the colPic memory 117 when the co-located information merge flag is ON. Specifically, FIG. 7 illustrates an example in which the current block has a motion vector per sub-block of 4×4 pixels and the colPic memory 117 has a storage area for one sub-block per block to be coded.

When writing information to the colPic memory 117, the colPic information writing unit 119 preferentially selects a motion vector for a block whose prediction direction corresponds to the bi-directional prediction and which is other than the block coded in the intra prediction, from among the motion vectors within the current block. Then, the colPic information writing unit 119 writes the selected motion vector for one sub-block as a representative motion vector, to the colPic memory 117.

As such, selecting a motion vector for a block other than the block coded in the intra prediction enables increase in the precision of the representative motion vector, which can consequently increase the precision of the temporal motion vector predictor and the coding efficiency. Furthermore, preferentially selecting a motion vector in the bi-directional prediction with which a predicted image with relatively less noise due to, for example, calculation of a weighted average can be generated enables increase in the precision of the representative motion vector, which can consequently increase the precision of the temporal motion vector predictor and the coding efficiency.

On the other hand, when reading information from the colPic memory 117, the colPic information reading unit 118 reads the representative motion vector stored in the colPic memory 117.

Then, the colPic information reading unit 118 scales, in a method to be described later, the representative motion vector, using a reference picture index (hereinafter referred to as “representative reference picture index”) associated with the representative motion vector, and a reference picture index for each sub-block. Then, the colPic information reading unit 118 sets the scaled motion vector to each of the sub-blocks.

As such, the colPic information reading unit 118 scales the representative motion vector according to the reference picture index for each of the sub-blocks, and sets the scaled motion vector to each of the sub-blocks. Thus, the precision of the temporal motion vector predictor generated from the motion vector and the coding efficiency can be increased.

As such, when the co-located information merge flag is ON, selecting a representative motion vector from the motion vectors in the current block and storing only the representative motion vector in the colPic memory 117, in writing information to the colPic memory 117 enables reduction in the capacity and the memory bandwidth of the colPic memory 117. In the example of FIG. 7, the capacity and the bandwidth of the colPic memory 117 necessary for each of the current blocks are reduced to 1/16.

Embodiment 1 describes, but not limited to, that the current block has a motion vector per sub-block of 4×4 pixels. When the current block has a motion vector per sub-block of N×M pixels, the memory amount and the bandwidth can be reduced by 1/(N×M).

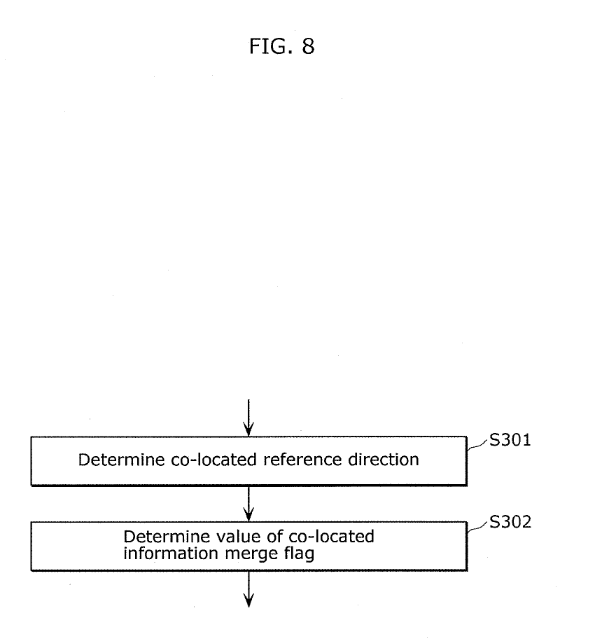

FIG. 8 is a detailed procedure of the determining process (S101) in FIG. 2. FIG. 8 will be described hereinafter. The co-located information determining unit 115 determines one of a forward reference block and a backward reference block, as a co-located block (S301). For example, the co-located information determining unit 115 may determine one of a forward reference picture including a forward reference block and a backward reference picture including a backward reference block, as a picture closer to the current picture in display order to determine a reference direction of the co-located block.

Furthermore, the co-located information determining unit 115 generates a co-located reference direction flag indicating that the co-located block is a forward reference block or a backward reference block for each picture, and attaches the generated flag to the picture.

Next, the co-located information determining unit 115 determines whether or not to reduce the number of motion vectors to be stored in the colPic memory 117 (S302). For example, when the memory bandwidth for suppressing the delay is reduced or the capacity of the colPic memory 117 is reduced, the number of motion vectors to be stored in the colPic memory 117 is probably reduced.

Then, the co-located information determining unit 115 generates a co-located information merge flag representing reduction of the number of motion vectors to be stored in the colPic memory 117 for each picture, and attaches the generated flag to the picture.

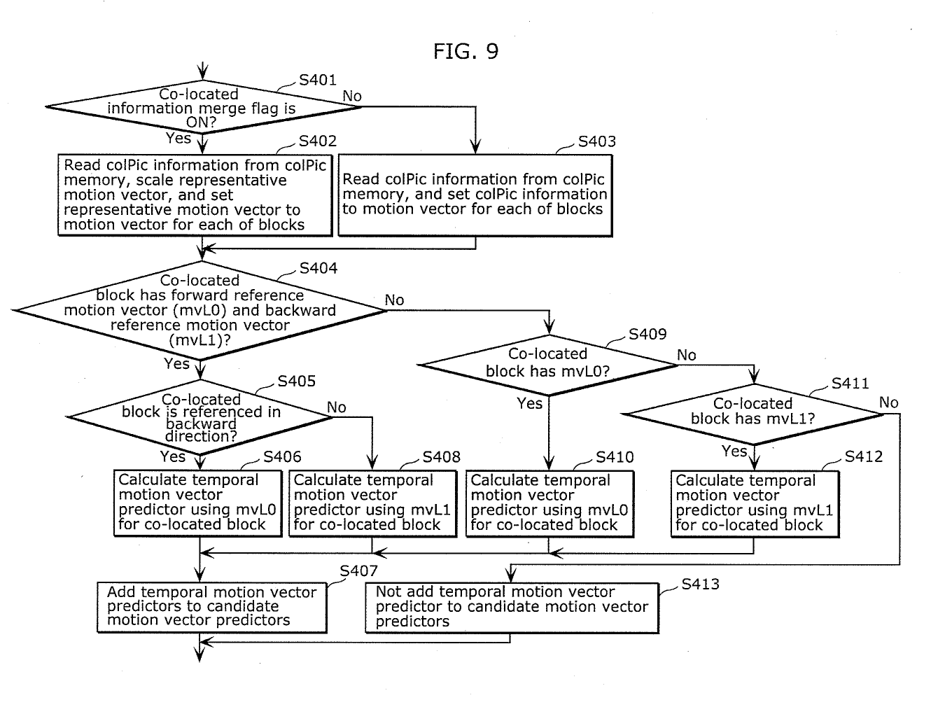

FIG. 9 is a detailed procedure of the adding process (S102) in FIG. 2. FIG. 9 will be described hereinafter. The temporal motion vector predictor calculating unit 116 determines whether or not the co-located information merge flag is ON (S401). If true (Yes at S401), the temporal motion vector predictor calculating unit 116 reads the colPic information from the colPic memory 117, scales a representative motion vector in a method to be described later, and sets the representative motion vector to a motion vector for each of the blocks (S402).

When the co-located information merge flag is OFF (No at S401), the temporal motion vector predictor calculating unit 116 reads the colPic information from the colPic memory 117, and sets the colPic information to a motion vector for each of the blocks (S403).

The temporal motion vector predictor calculating unit 116 determines whether or not the co-located block included in the colPic information has two or more motion vectors, that is, at least a forward reference motion vector (mvL0) and a backward reference motion vector (mvL1) (S404).

When determining that the co-located block has two or more motion vectors (Yes at S404), the temporal motion vector predictor calculating unit 116 determines whether or not the co-located block is a backward reference block (S405). When determining that the co-located block is a backward reference block (Yes at S405), the temporal motion vector predictor calculating unit 116 derives a temporal motion vector predictor in the temporal motion vector predictor mode, using the forward reference motion vector for the co-located block (S406).

When determining that the co-located block is a forward reference block (No at S405), the temporal motion vector predictor calculating unit 116 derives a temporal motion vector predictor in the temporal motion vector predictor mode, using the backward reference motion vector for the co-located block (S408).

When determining that the co-located block has neither the forward reference motion vector nor the backward reference motion vector (No at S404), the temporal motion vector predictor calculating unit 116 determines whether or not the co-located block has a forward reference motion vector (S409).

When determining that the co-located block has a forward reference motion vector (Yes at S409), the temporal motion vector predictor calculating unit 116 derives a temporal motion vector predictor for the current block using the forward reference motion vector for the co-located block (S410). When determining that the co-located block does not have the forward reference motion vector (No at S409), the temporal motion vector predictor calculating unit 116 determines whether or not the co-located block has a backward reference motion vector (S411).

When determining that the co-located block has a backward reference motion vector (Yes at S411), the temporal motion vector predictor calculating unit 116 derives a temporal motion vector predictor for the current block using the backward reference motion vector for the co-located block (S412). When determining that the co-located block does not have a backward reference motion vector (No at S411), the temporal motion vector predictor calculating unit 116 does not add the temporal motion vector predictor of the co-located block to candidate motion vector predictors or adds the temporal motion vector predictor to the candidate motion vector predictors by setting 0 to the temporal motion vector predictor (S413).

Finally, the temporal motion vector predictor calculating unit 116 adds the temporal motion vector predictors derived based on the reference motion vectors (S406, S408, S410, and S412) to the candidate motion vector predictors (S407).

In FIG. 9, after determining whether or not the co-located block has a forward reference motion vector (S409), the temporal motion vector predictor calculating unit 116 determines whether or not the co-located block has a backward reference motion vector (S411). However, the processes are not limited to such. For example, after determining whether or not the co-located block has a backward reference motion vector, the temporal motion vector predictor calculating unit 116 may determine whether or not the co-located block has a forward reference motion vector.

Next, a method for deriving a temporal motion vector predictor in the temporal motion vector predictor mode will be described in detail.

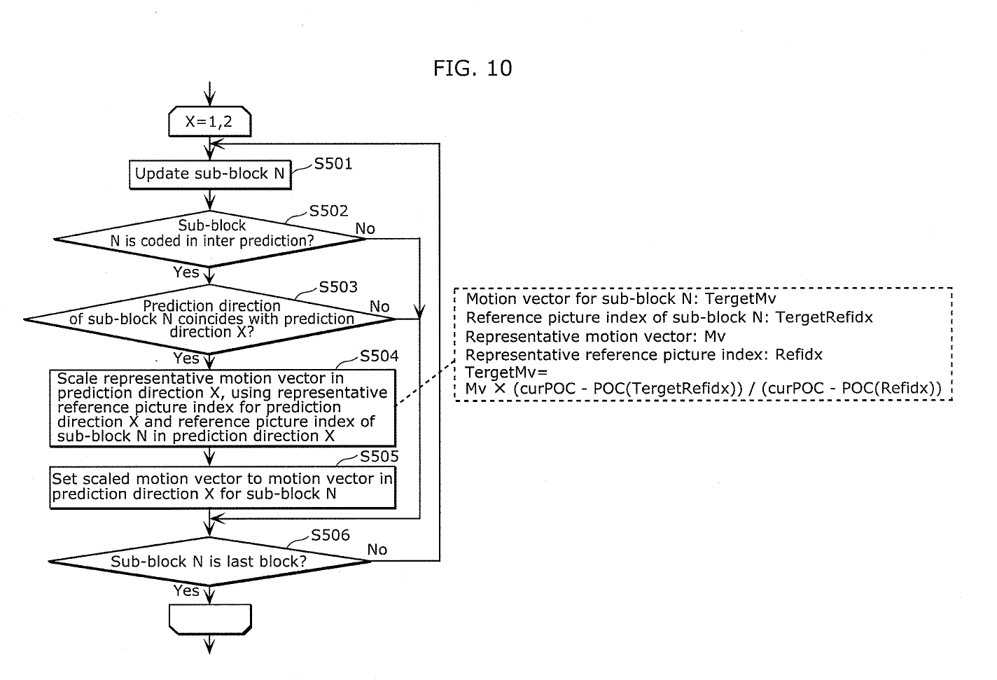

FIG. 10 is a detailed procedure of the setting process (S402) in FIG. 9. FIG. 10 will be described hereinafter. With respect to the prediction direction X (X=1, 2), the temporal motion vector predictor calculating unit 116 selects one sub-block N that is a unit for holding a motion vector in the current block, for example, in raster order (S501). Then, the temporal motion vector predictor calculating unit 116 determines whether or not the sub-block N is a block coded in the inter prediction, using, for example, the read colPic information (S502).

When a result of the determination on the inter prediction is false (No at S502), the temporal motion vector predictor calculating unit 116 determines whether or not the sub-block N is the last sub-block in the current block (S506). When a result of the determination on the last sub-block is true (Yes at S506), the temporal motion vector predictor calculating unit 116 ends the processes. When the result of the determination on the last sub-block is false (No at S506), the temporal motion vector predictor calculating unit 116 proceeds to the processes for the next sub-block (S501).

When the result of the determination on the inter prediction is true (S502), the temporal motion vector predictor calculating unit 116 determines whether or not the prediction direction of the sub-block N coincides with the prediction direction X, using, for example, the colPic information (S503). When a result of the determination on the prediction direction is false (No at S503), the temporal motion vector predictor calculating unit 116 determines whether or not the sub-block N is the last sub-block (S506).

When the result of the determination on the prediction direction is true (Yes at S503), the temporal motion vector predictor calculating unit 116 scales a representative motion vector in the prediction direction X using a representative reference picture index for the prediction direction X and a reference picture index of the sub-block N with the following equation to derive a motion vector for the sub-block N (S504).

TargetMv=My×(curPOC−POC(TargetRefidx))/(curPOC−POC(Refidx)) (Equation 4)

Here, TargetMv denotes a motion vector for the sub-block N, My denotes a representative motion vector, curPOC denotes a display order of the current picture, TargetRefidx denotes a reference picture index of the sub-block N, and Refidx denotes a representative reference picture index. Furthermore, POC(X) denotes a display order of a reference picture indicated by a reference picture index X in a reference picture list for the current picture.

The temporal motion vector predictor calculating unit 116 sets the scaled motion vector (S504) to the motion vector in the prediction direction X for the sub-block N (S505). Then, the temporal motion vector predictor calculating unit 116 determines whether or not the sub-block N is the last sub-block (S506).

As such, the temporal motion vector predictor calculating unit 116 scales a representative motion vector according to a reference picture index of each of the sub-blocks, and sets the scaled motion vector to each of the sub-blocks. Accordingly, the precision of the temporal motion vector predictor generated from the motion vector and the coding efficiency can be increased.

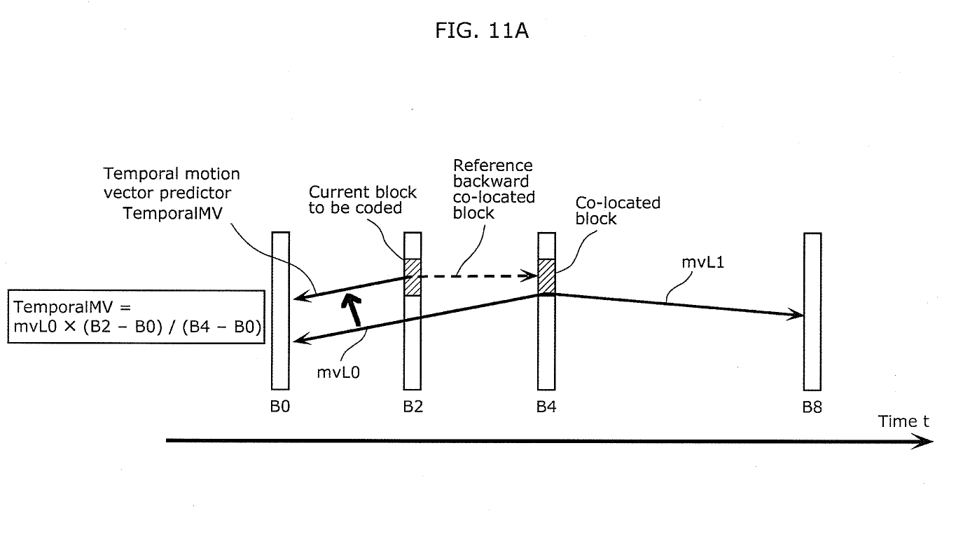

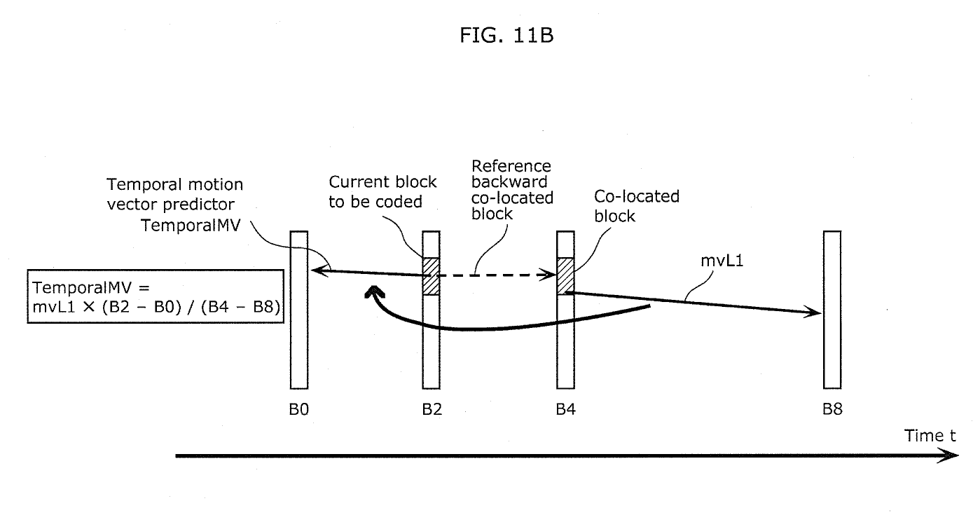

FIG. 11A illustrates, when the co-located block is a backward reference block and has a forward reference motion vector and a backward reference motion vector, a method for deriving a motion vector predictor candidate (temporal motion vector predictor) using the forward reference motion vector in the temporal motion vector predictor mode. The temporal motion vector predictor calculating unit 116 derives a motion vector predictor candidate (TemporalMV) using the forward reference motion vector, using the following equation.

TemporalMV=mvL0×(B2−B0)/(B4−B0) (Equation 5)

Here, (B2−B0) is temporal difference information in display time between a picture B2 and a picture B0, and (B4−B0) is temporal difference information in display time between a picture B4 and the picture B0.

FIG. 11B illustrates a method for deriving a motion vector predictor candidate (temporal motion vector predictor) using the backward reference motion vector in the temporal motion vector predictor mode. The temporal motion vector predictor calculating unit 116 derives a motion vector predictor candidate using the backward reference motion vector, using the following equation.

TemporalMV=mvL1×(B2−B0)/(B4−B8) (Equation 6)

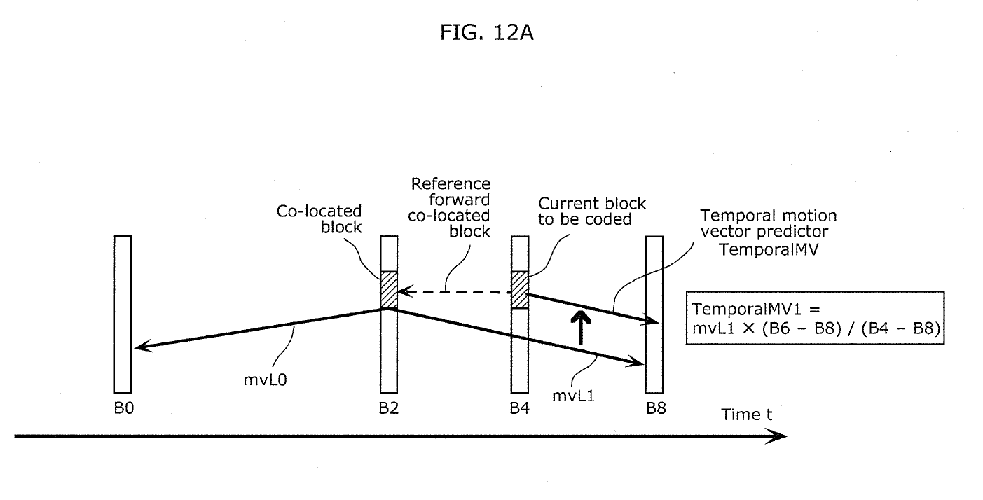

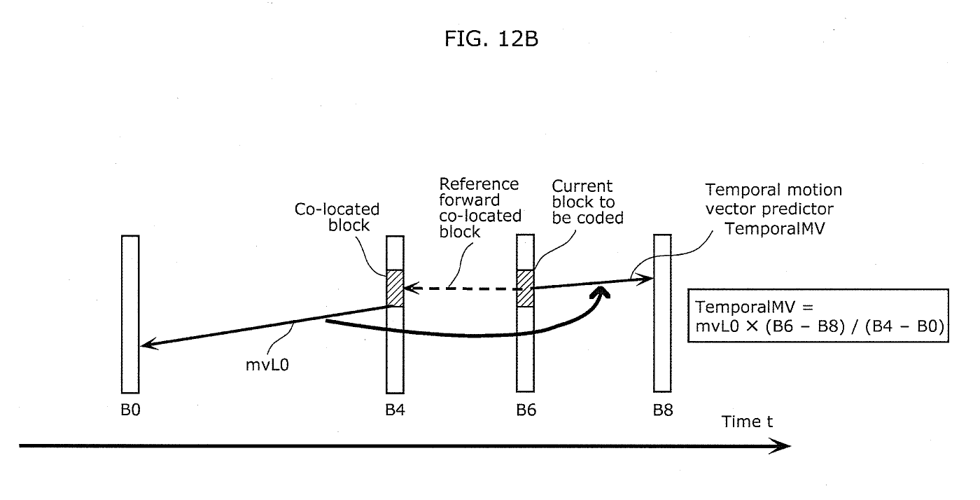

FIG. 12A illustrates, when the co-located block is a forward reference block and has a forward reference motion vector and a backward reference motion vector, a method for deriving a motion vector predictor candidate (temporal motion vector predictor) using the backward reference motion vector in the temporal motion vector predictor mode. The temporal motion vector predictor calculating unit 116 derives a motion vector predictor candidate using the backward reference motion vector, using the following equation.

TemporalMV=mvL1×(B6−B8)/(B4−B8) (Equation 7)

FIG. 12B illustrates a method for deriving a motion vector predictor candidate (temporal motion vector predictor) using the forward reference motion vector in the temporal motion vector predictor mode. The temporal motion vector predictor calculating unit 116 derives a motion vector predictor candidate using the forward reference motion vector, using the following equation.

TemporalMV=mvL0×(B6−B8)/(B4−B0) (Equation 8)

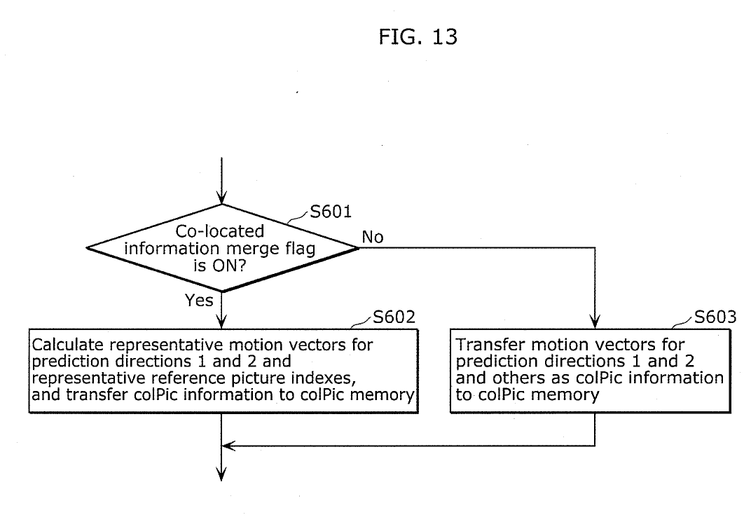

FIG. 13 is a detailed procedure of the transferring process (S104) in FIG. 2. FIG. 13 will be described hereinafter. The inter prediction control unit 114 determines whether or not the co-located information merge flag is ON (S601).

When a result of the determination is true (Yes at S601), the inter prediction control unit 114 calculates representative motion vectors for the prediction directions 1 and 2 and representative reference picture indexes, using the motion vectors for the current block in a method to be described later. Then, the inter prediction control unit 114 adds the representative motion vectors to the colPic information in place of the motion vectors for the current block, and transfers the colPic information to the colPic memory 117 (S602).

When the result of the determination is false (No at S601), the inter prediction control unit 114 transfers the motion vectors and others for the prediction directions 1 and 2 of the current block, as the colPic information to the colPic memory 117 (S603).

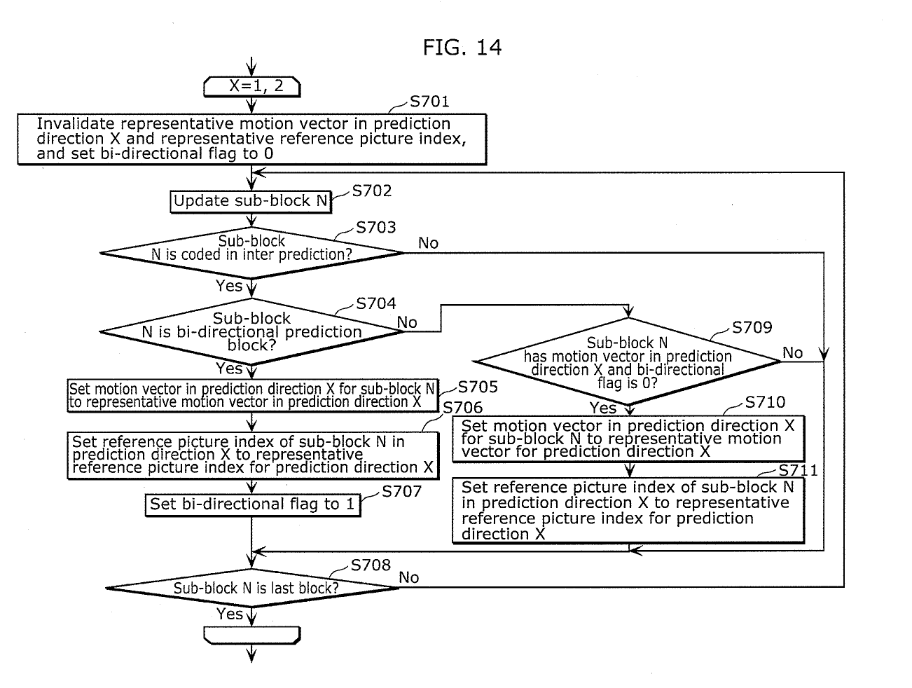

FIG. 14 is a detailed procedure of the transferring process (S602) in FIG. 13. FIG. 14 will be described hereinafter. With respect to the prediction direction X (X=1, 2), the inter prediction control unit 114 initializes a representative motion vector in the prediction direction X, the representative reference picture index, and a bi-directional flag (S701). According to Embodiment 1, the inter prediction control unit 114 invalidates the representative motion vector and the representative reference picture index as initial values, and sets the bi-directional flag to 0.

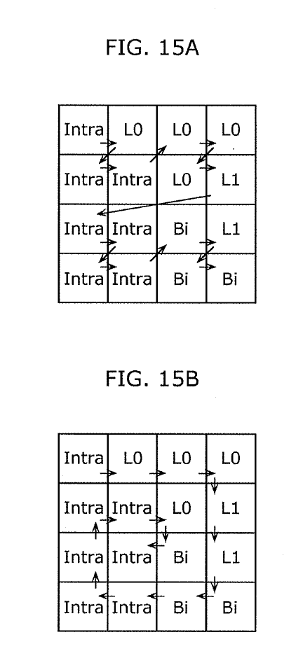

Next, the inter prediction control unit 114 selects one sub-block N that is a unit for holding a motion vector in the current block, for example, in scan (zigzag scan) order from a sub-block to the upper left of the current block as illustrated in FIG. 15A (S702). Then, the inter prediction control unit 114 determines whether or not the sub-block N is a block coded in the inter prediction (S703).

When a result of the determination on the inter prediction is true (Yes at S703), the inter prediction control unit 114 determines whether or not the prediction direction of the sub-block N in the inter prediction corresponds to bi-directional prediction (S704).

When the result of the determination on the bi-directional prediction is true (Yes at S704), the inter prediction control unit 114 sets the motion vector in the prediction direction X for the sub-block N to the representative motion vector for the prediction direction X (S705). Furthermore, the inter prediction control unit 114 sets the reference picture index of the sub-block N in the prediction direction X to the representative reference picture index for the prediction direction X (S706). Then, the inter prediction control unit 114 sets the bi-directional flag to 1 (S707).

As such, when the sub-block N is a bi-directional prediction block with which a predicted image with relatively less noise due to, for example, calculation of a weighted average can be generated, the inter prediction control unit 114 preferentially sets the motion vector as a representative motion vector. Thus, increase in the precision of the representative motion vector can consequently increase the precision of the temporal motion vector predictor and the coding efficiency.

When the result of the determination on the bi-directional prediction is false (No at S704), that is, when the sub-block N is not the bi-directional prediction block, the inter prediction control unit 114 makes the next determination. In other words, the inter prediction control unit 114 determines whether or not the sub-block N has a motion vector in the prediction direction X and the bi-directional flag is 0 (no sub-block for the bi-directional prediction is found in the sub-blocks of the current block) (S709).

When the result of the determination on the prediction direction is true (Yes at S709), the inter prediction control unit 114 sets the motion vector in the prediction direction X for the sub-block N to the representative motion vector for the prediction direction X (S710). Furthermore, the inter prediction control unit 114 sets the reference picture index of the sub-block N in the prediction direction X to the representative reference picture index for the prediction direction X (S711).

As such, when the sub-blocks in the current block do not have any motion vector in the bi-directional prediction, the inter prediction control unit 114 sets a motion vector for the unidirectional prediction that coincides with the prediction direction X as a representative motion vector, thus enabling increase in the coding efficiency.

When the result of the determination on the inter prediction is false (No at S703) or when the result of the determination on the prediction direction is false (No at S709), that is, when the sub-block N is a block coded in the intra prediction or does not have any motion vector in the prediction direction X, the inter prediction control unit 114 determines whether or not the sub-block N is the last sub-block in the current block (S708).

As such, when the sub-block N is a block coded in the intra prediction or does not have any motion vector in the prediction direction X, the inter prediction control unit 114 can increase the coding efficiency by not setting any representative motion vector.

When the result of the determination on the last sub-block is true (Yes at S708), the inter prediction control unit 114 ends the processes. When the result of the determination on the last sub-block is false (No at S708), the inter prediction control unit 114 performs the processes on the next sub-block (S702).

When neither representative motion vector in the prediction direction X nor representative reference picture index is found after completion of the processes on all the sub-blocks, the inter prediction control unit 114 may set values representing invalidity to values of the representative motion vector in the prediction direction X and the representative reference picture index, and add the representative motion vector in the prediction direction X and the representative reference picture index to the colPic information. Here, the inter prediction control unit 114 may remove the representative motion vector from the colPic information to reduce the data amount of the colPic information.

Searching motion vectors in the current block for a representative motion vector, for example, in scan order as illustrated in FIG. 15A and updating the value of the representative motion vector enable selection of the representative motion vector with higher precision that is less susceptible to the edges of a screen and others, and increase in the coding efficiency. Although in Embodiment 1, a representative motion vector is searched in scan order from a sub-block to the upper left of the current block as illustrated in FIG. 15A, the searching is not limited to such.

For example, the representative motion vector may be searched, for example, in raster scan order from the upper left to the lower right or from the lower right to the upper left of the current block in the current picture according to the position of the current block in the current picture. Furthermore, as illustrated in FIG. 15B, the representative motion vector may be searched, for example, in a clockwise direction from the upper left toward the center of the current block. The searching enables selection of the representative motion vector that is closer to the center of the current block and is less susceptible to the edges of a screen, and increase in the coding efficiency.

Furthermore, it is possible to start searching for a representative motion vector, stop the searching when the first sub-block in the bi-directional prediction has been detected, and determine the motion vector for the sub-block detected first in the bi-directional prediction as the representative motion vector. Determining the motion vector for the sub-block detected first in the bi-directional prediction as the representative motion vector enables reduction in the processing amount and increase in the coding efficiency. Here, the inter prediction control unit 114 may search for a representative motion vector in an order opposite to that of FIG. 15B.

As such, the image coding apparatus according to Embodiment 1 uses a new criterion for appropriately controlling motion vector information to be held in a memory in the temporal motion vector predictor mode. Accordingly, the necessary memory capacity and bandwidth in the temporal motion vector predictor mode can be reduced.

More specifically, when the co-located information merge flag is ON, the image coding apparatus selects the representative motion vector from among the motion vectors for the sub-blocks in the current block by prioritizing motion vectors in the bi-directional prediction in writing the colPic information to the colPic memory 117. Then, the image coding apparatus can reduce the capacity and the memory bandwidth of the colPic memory 117 by storing, in the colPic memory 117, the representative motion vector in place of the motion vector for each of the sub-blocks.

Furthermore, the image coding apparatus scales the representative motion vector according to the reference picture index for each of the sub-blocks, in reading the colPic information from the colPic memory 117. Then, the image coding apparatus sets the scaled motion vector to each of the sub-blocks. Accordingly, the image coding apparatus can increase the precision of the temporal motion vector predictor generated from the motion vector and the coding efficiency.

According to Embodiment 1, when the co-located block has two or more motion vectors to be used in calculating a temporal motion vector predictor for the current block, the motion vectors are switched according to whether the co-located block is a backward reference block or a forward reference block.

However, the temporal motion vector predictor may be calculated using a motion vector that references a reference picture temporally closer (motion vector whose temporal distance is shorter) to a picture including the co-located block. Here, the temporal distance is probably determined in display time order according to the number of pictures between the picture including the co-located block and the reference picture to be referenced by the co-located block.

Furthermore, the temporal motion vector predictor may be calculated, using a motion vector having a smaller magnitude out of two motion vectors for the co-located block. Here, the magnitude of a motion vector means an absolute value of the motion vector.

Furthermore, Embodiment 1 describes, but not limited to, selecting a representative motion vector from among the motion vectors for the current block, and writing the colPic information including the representative motion vector to a memory when the co-located information merge flag is ON. For example, when the co-located information merge flag is ON, the number of reference picture indexes is probably reduced and stored as well as the motion vectors for the current block.

Here, the representative motion vector and the representative reference picture index calculated through the procedure in FIG. 14 are stored in place of the motion vector and the reference picture index for each of the sub-blocks in the colPic information. In reading the colPic information, the representative motion vector and the representative reference picture index are set to the motion vector and the reference picture index for each of the sub-blocks without scaling the representative motion vector, according to the procedure in FIG. 10.

Accordingly, since the number of the reference picture indexes as well as the motion vectors in the colPic information that are to be stored in the colPic memory 117 can be reduced, the memory capacity and the bandwidth can be further reduced.

### Embodiment 2

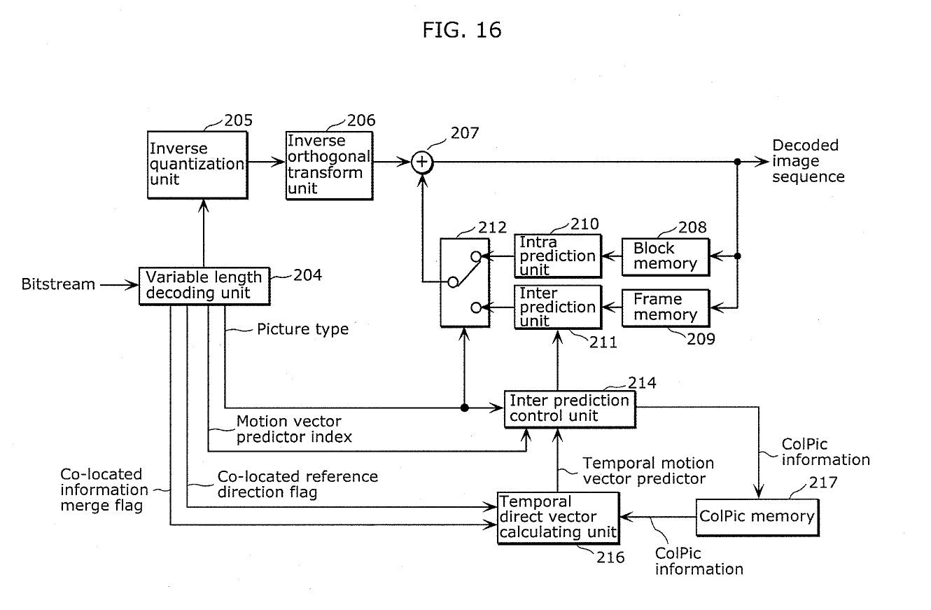

FIG. 16 is a block diagram illustrating a configuration of an image decoding apparatus according to Embodiment 2.

In Embodiment 2, a block included in a picture preceding the current picture to be decoded in display time order will be referred to as a forward reference block. Furthermore, a block included in a picture following the current picture in display time order will be referred to as a backward reference block.

As illustrated in FIG. 16, the image decoding apparatus includes a variable length decoding unit 204, an inverse quantization unit 205, an inverse orthogonal transform unit 206, an adding unit 207, a block memory 208, a frame memory 209, an intra prediction unit 210, an inter prediction unit 211, a switch unit 212, an inter prediction control unit 214, and a temporal motion vector predictor calculating unit 216, and a colPic memory 217.

The variable length decoding unit 204 variable-length decodes an input bitstream to generate picture type information, a motion vector predictor index, a co-located reference direction flag, a co-located information merge flag, and a bitstream that are variable-length decoded. The inverse quantization unit 205 inversely quantizes the bitstream that is variable-length decoded. The inverse orthogonal transform unit 206 transforms the bitstream that is inversely quantized, from a frequency domain to an image domain to generate prediction error image data.

The block memory 208 is a memory for storing an image sequence generated by adding the prediction error image data to predicted image data, per block. The frame memory 209 is a memory for storing the image sequence per frame.

The intra prediction unit 210 performs intra-prediction on the image sequence stored per block in the block memory 208 to generate prediction error image data of the current block. The inter prediction unit 211 performs inter-prediction on the image sequence stored per frame in the frame memory 209 to generate prediction error image data of the current block.

The temporal motion vector predictor calculating unit 216 derives motion vector predictor candidates (temporal motion vector predictors) in the temporal motion vector predictor mode, using the colPic information for the motion vectors for the co-located block that are stored in the colPic memory 217. Furthermore, the temporal motion vector predictor calculating unit 216 allocates a value of a motion vector predictor index corresponding to each of the temporal motion vector predictors. Furthermore, the temporal motion vector predictor calculating unit 216 transmits, to the inter prediction control unit 214, the temporal motion vector predictor and the motion vector predictor index.

When the co-located block does not have any motion vector, the temporal motion vector predictor calculating unit 216 may stop deriving a motion vector in the temporal motion vector predictor mode, or derive a motion vector predictor candidate (temporal motion vector predictor) by setting 0 to the motion vector.

The inter prediction control unit 214 determines a motion vector to be used in the inter prediction among the motion vector predictor candidates, based on the motion vector predictor index. Furthermore, the inter prediction control unit 214 generates the motion vector to be used in the inter prediction by adding the prediction error information of the motion vector predictor candidate to the value of the determined motion vector predictor candidate.

Furthermore, the inter prediction control unit 214 transfers the colPic information including the motion vector for the current block, to the colPic memory 217 according to a value of the co-located information merge flag.

Finally, the adding unit 207 adds the decoded predicted image data to the prediction error image data to generate a decoded image sequence.

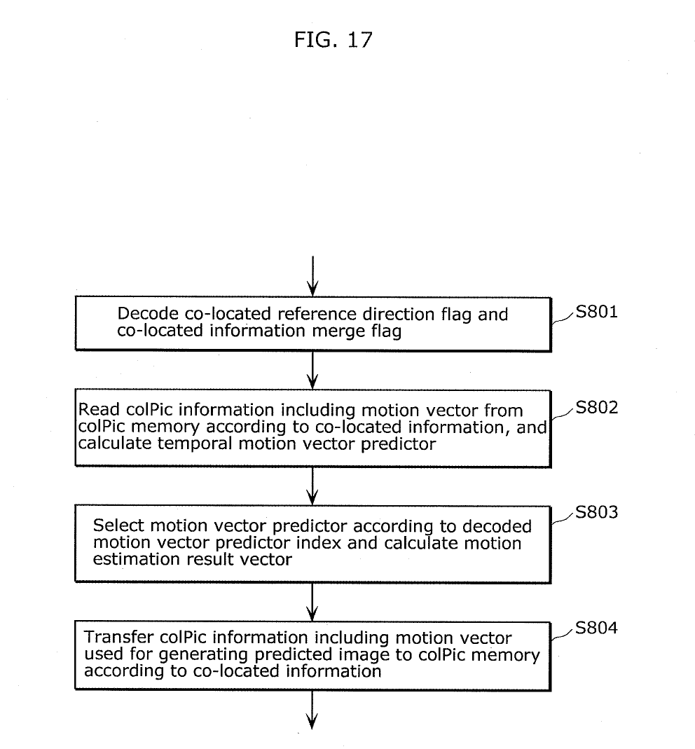

FIG. 17 shows an outline of processes of an image decoding method according to Embodiment 2. The variable length decoding unit 204 decodes and obtains a co-located reference direction flag and a co-located information merge flag per picture (S801). Then, the temporal motion vector predictor calculating unit 216 determines one of the forward reference block and the backward reference block as a co-located block, based on the co-located reference flag.

Next, the temporal motion vector predictor calculating unit 216 reads the colPic information including the reference motion vector for the co-located block, from the colPic memory 217 according to the co-located information in the same manner as shown in FIGS. 9 and 10. Then, the temporal motion vector predictor calculating unit 216 derives a motion vector predictor candidate (temporal motion vector predictor) in the temporal motion vector predictor mode, using the reference motion vectors for the co-located block (S802).

Next, the inter prediction control unit 214 determines a motion vector to be used in the inter prediction among the motion vector predictor candidates, based on the decoded motion vector predictor index. Furthermore, the inter prediction control unit 214 derives the motion vector by adding the prediction error information to the determined motion vector predictor candidate (S803).

The inter prediction unit 211 performs inter-prediction decoding using the derived motion vector. The inter prediction control unit 214 transfers the colPic information including the motion vector used in the inter prediction, to the colPic memory 217 according to the co-located information merge flag in the same manner as shown in FIGS. 13 and 14, and stores the colPic information in the colPic memory 217 (S804). The colPic memory 217 stores a motion vector for a reference picture, an index value of the reference picture, and a prediction direction for calculating the temporal motion vector predictor for the current block.

When the reference block has two or more reference motion vectors, the method for selecting a reference motion vector for calculating a temporal motion vector predictor does not have to depend on a flag and others. For example, temporal distances to respective reference motion vectors may be calculated, and one of the reference motion vectors having a shorter temporal distance may be used. Here, the temporal distance is calculated in display time order based on the number of pictures between a reference picture including a reference block and a picture to be referenced by the reference picture.

Furthermore, for example, magnitudes of reference motion vectors may be calculated, and a motion vector derived using the reference motion vector having a smaller magnitude may be determined as the temporal motion vector predictor.

As such, the image decoding apparatus according to Embodiment 2 uses a new criterion for appropriately controlling motion vector information to be held in a memory in the temporal motion vector predictor mode. Accordingly, the necessary memory capacity and bandwidth in the temporal motion vector predictor mode can be reduced.

More specifically, when the decoded co-located information merge flag is ON, the image decoding apparatus selects a representative motion vector from among the motion vectors for the sub-blocks in the current block by prioritizing motion vectors in the bi-directional prediction in writing the colPic information to the colPic memory 217. Then, the image decoding apparatus can reduce the capacity and the memory bandwidth of the colPic memory 217 by storing, in the colPic memory 217, the representative motion vector in place of the motion vector for each of the sub-blocks.

Furthermore, the image decoding apparatus scales the representative motion vector according to the reference picture index for each of the sub-blocks, in reading the colPic information from the colPic memory 217. Then, the image decoding apparatus sets the scaled motion vector to each of the sub-blocks. Accordingly, the image decoding apparatus can increase the precision of the temporal motion vector predictor generated from the motion vector and the coding efficiency.

Although the image coding apparatus and the image decoding apparatus according to the present invention are described based on Embodiments, the present invention is not limited to Embodiments. The present invention includes modifications conceived by a person skilled in the art using Embodiments, and other embodiments arbitrarily combining the constituent elements included in Embodiments.

For example, processes performed by a particular processing unit may be performed by another processing unit. Furthermore, the order of performing the processes may be changed, and a plurality of processes may be executed in parallel.

Furthermore, the image coding apparatus and the image decoding apparatus according to the present invention may be implemented as an image coding and decoding apparatus including the constituent elements included in the image coding apparatus and the image decoding apparatus.

Furthermore, the present invention may be implemented not only as the image coding apparatus and the image decoding apparatus but also as methods using respective processing units included in the image coding apparatus and the image decoding apparatus as steps. Furthermore, the present invention can be implemented for causing a computer to execute the steps included in each of the methods as a program. Furthermore, the present invention can be implemented as a non-transitory computer-readable recording medium, such as a CD-ROM on which the program is recorded.

Furthermore, the constituent elements included in the image coding apparatus and the image decoding apparatus may be implemented as a large-scale integration (LSI) that is an integrated circuit. The constituent elements may be separately made into one chip, or a part or an entire thereof may be made into one chip. The name used here is LSI, but it may also be called integrated circuit (IC), system LSI, super LSI, or ultra LSI depending on the degree of integration.

Moreover, ways to achieve integration are not limited to the LSI, and a special circuit or a general purpose processor can also achieve the integration. Field Programmable Gate Array (FPGA) that can be programmed or a reconfigurable processor that allows re-configuration of the connection and setting of circuit cells in an LSI may be used for the same purpose.

In the future, with advancement in semiconductor technology, a brand-new technology may replace LSI. The constituent elements included in each of the image coding apparatus and the image decoding apparatus can be integrated into a circuit using such a technology.

### Embodiment 3

The processing described in each of Embodiments can be simply implemented by recording, onto a recording medium, a program for implementing a moving picture coding method (image coding method) or a moving picture decoding method (image decoding method) described in each of Embodiments. The recording medium may be any recording medium as long as a program can be recorded thereon, such as a magnetic disk, an optical disc, a magnetic optical disc, an IC card, and a semiconductor memory.

Hereinafter, the applications to the moving picture coding method (image coding method) and the moving picture decoding method (image decoding method) described in each of Embodiments and a system using thereof will be described. The system includes an image coding and decoding apparatus including an image coding apparatus using an image coding method and an image decoding apparatus using an image decoding method. Other configurations in the system can be appropriately changed according to each individual case.

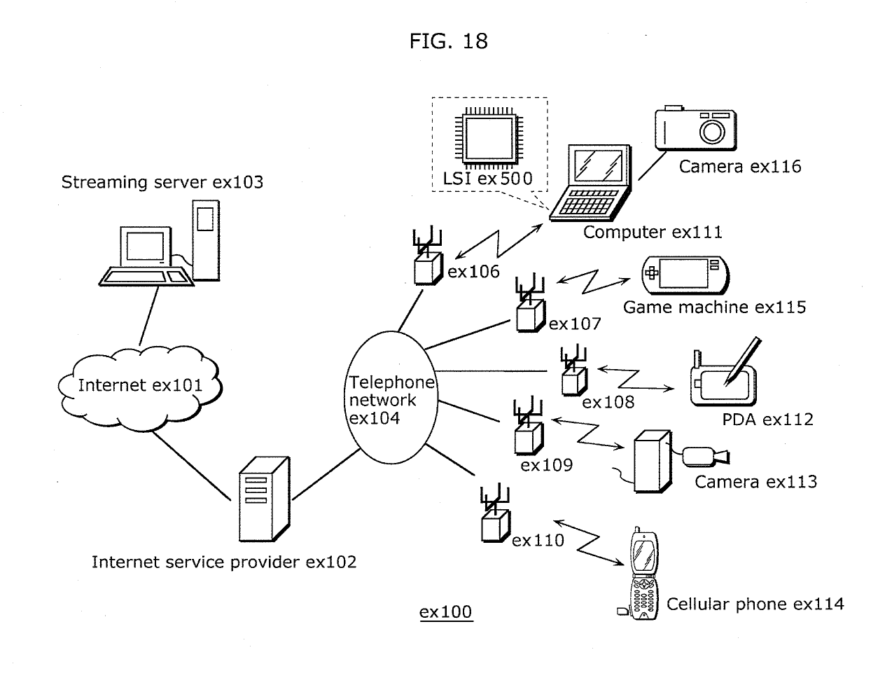

FIG. 18 illustrates an overall configuration of a content providing system ex100 for implementing content distribution services. The area for providing communication services is divided into cells of desired size, and base stations ex106 to ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110.

However, the configuration of the content providing system ex100 is not limited to the configuration shown in FIG. 18, and a combination in which any of the elements are connected is acceptable. In addition, each of the devices may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital video camera, is capable of capturing both still images and video. Furthermore, the cellular phone ex114 may be the one that meets any of the standards such as Global System for Mobile Communications (GSM), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of a live show and others. For such a distribution, a content (for example, video of a music live show) captured by the user using the camera ex113 is coded as described above in each of Embodiments, and the coded content is transmitted to the streaming server ex103. On the other hand, the streaming server ex103 carries out stream distribution of the received content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data (that is, functions as an image decoding apparatus according to the present invention).

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding images may be integrated into some type of a recording medium (such as a CD-ROM, a flexible disk, a hard disk) that is readable by the computer ex111 and others, and the coding and decoding processes may be performed using the software. Furthermore, when the cellular phone ex114 is equipped with a camera, the moving picture data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients can receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

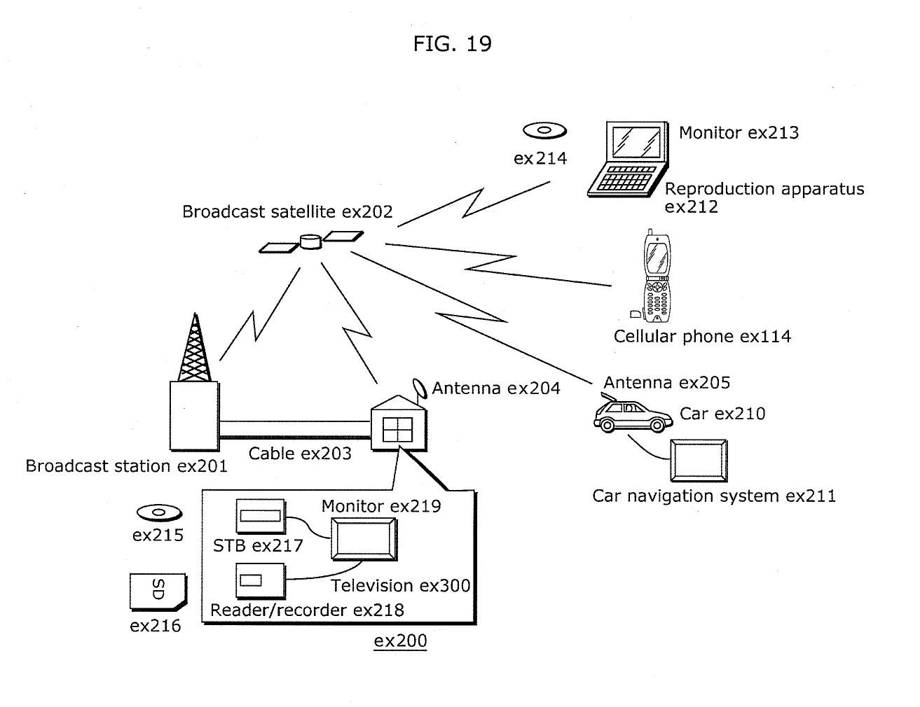

Aside from the example of the content providing system ex100, at least one of the moving picture coding apparatus (image coding apparatus) and the moving picture decoding apparatus (image decoding apparatus) described in each of Embodiments may be implemented in a digital broadcasting system ex200 illustrated in FIG. 19. More specifically, a broadcast station ex201 communicates or transmits, via radio waves to a broadcast satellite ex202, multiplexed data obtained by multiplexing audio data and others onto video data. The video data is data coded by the moving picture coding method described in each of Embodiments (that is, data coded by the image coding apparatus according to the present invention). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data and reproduces the decoded data (that is, functions as the image decoding apparatus according to the present invention).

Furthermore, a reader/recorder ex218 that (i) reads and decodes the multiplexed data recorded on a recording media ex215, such as a DVD and a BD, or (ii) codes video signals in the recording medium ex215, and in some cases, writes data obtained by multiplexing an audio signal on the coded data can include the moving picture decoding apparatus or the moving picture coding apparatus as shown in each of Embodiments. In this case, the reproduced video signals are displayed on the monitor ex219, and can be reproduced by another device or system using the recording medium ex215 on which the multiplexed data is recorded. Furthermore, it is also possible to implement the image decoding apparatus in the set top box ex217 connected to the cable ex203 for a cable television or the antenna ex204 for satellite and/or terrestrial broadcasting, so as to display the video signals on the monitor ex219 of the television ex300. The moving picture decoding apparatus may be included not in the set top box but in the television ex300.

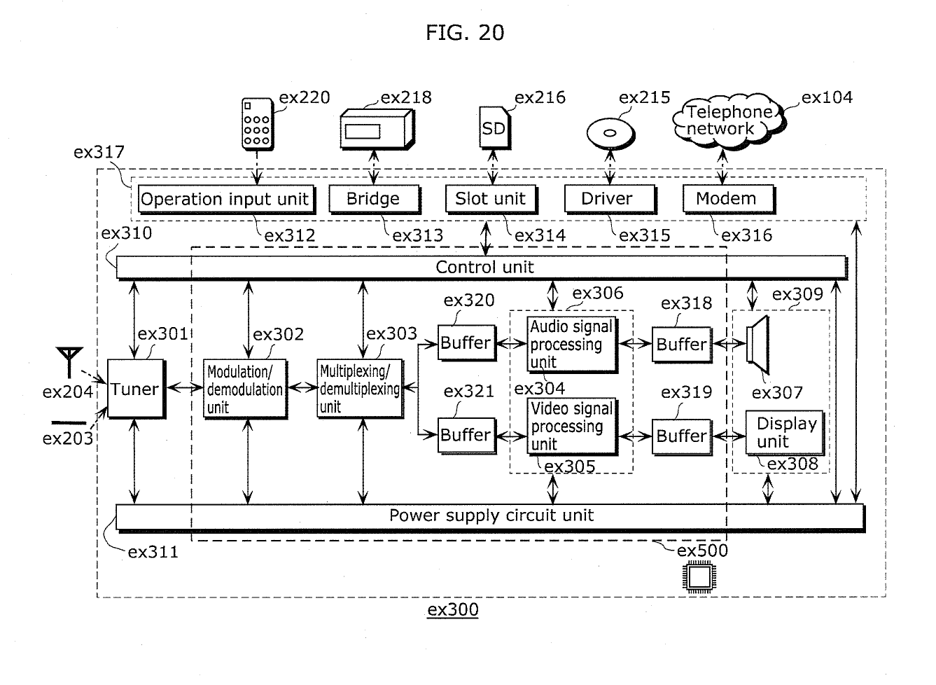

FIG. 20 illustrates the television (receiver) ex300 that uses the moving picture coding method and the moving picture decoding method described in each of Embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 (functioning as the image coding apparatus or the image decoding apparatus according to the present invention) that decode audio data and video data and code audio data and video data, respectively; a speaker ex307 that provides the decoded audio signal; and an output unit ex309 including a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to one another through a synchronous bus.

First, a configuration in which the television ex300 decodes data obtained from outside through the antenna ex204 and others and reproduces the decoded data will be described. In the television ex300, upon a user operation from a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of Embodiments in the television ex300. The output unit ex309 provides the decoded video signal and audio signal outside. When the output unit ex309 provides the video signal and the audio signal, the signals may be temporarily stored in buffers ex318 and ex319, and others so that the signals are reproduced in synchronization with each other. Furthermore, the television ex300 may read a coded bitstream not through a broadcast and others but from the recording media ex215 and ex216, such as a magnetic disk, an optical disc, and an SD card. Next, a configuration in which the television ex300 codes an audio signal and a video signal, and transmits the data outside or writes the data on a recording medium will be described. In the television ex300, upon a user operation from the remote controller ex220 and others, the audio signal processing unit ex304 codes an audio signal, and the video signal processing unit ex305 codes a video signal, under control of the control unit ex310 using the coding method described in each of Embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer other than the buffers ex318 to ex321 so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be not capable of performing all the processes but capable of only one of receiving, decoding, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

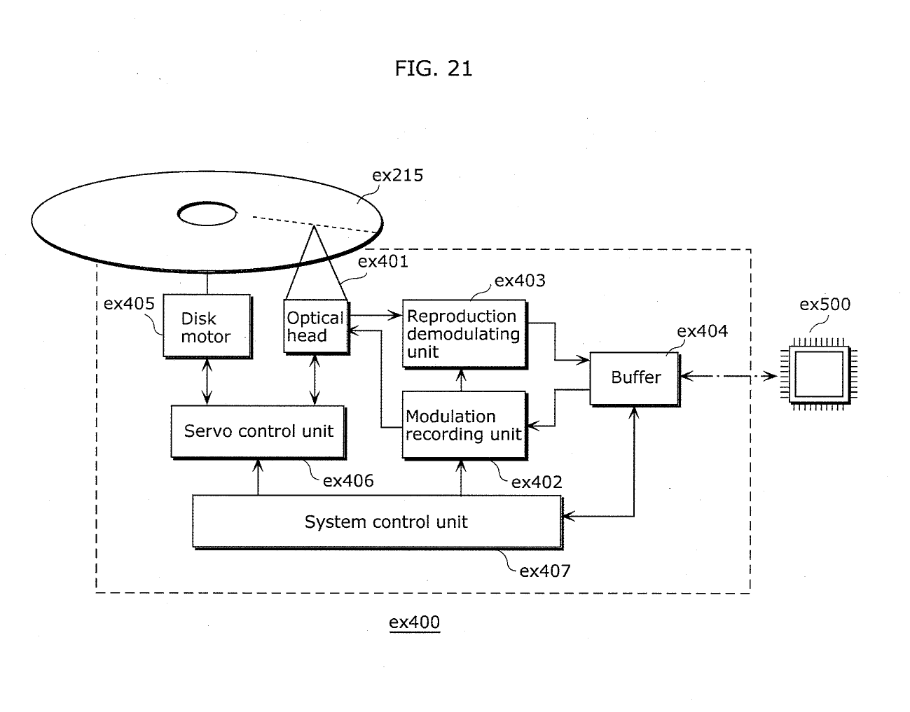

As an example, FIG. 21 illustrates a configuration of an information reproducing/recording unit ex400 when data is read or written from or in an optical disc. The information reproducing/recording unit ex400 includes constituent elements ex401, ex402, ex403, ex404, ex405, ex406, and ex407 to be described hereinafter. The optical head ex401 irradiates a laser spot on a recording surface of the recording medium ex215 that is an optical disc to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. A disk motor ex405 rotates the recording medium ex215. A servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

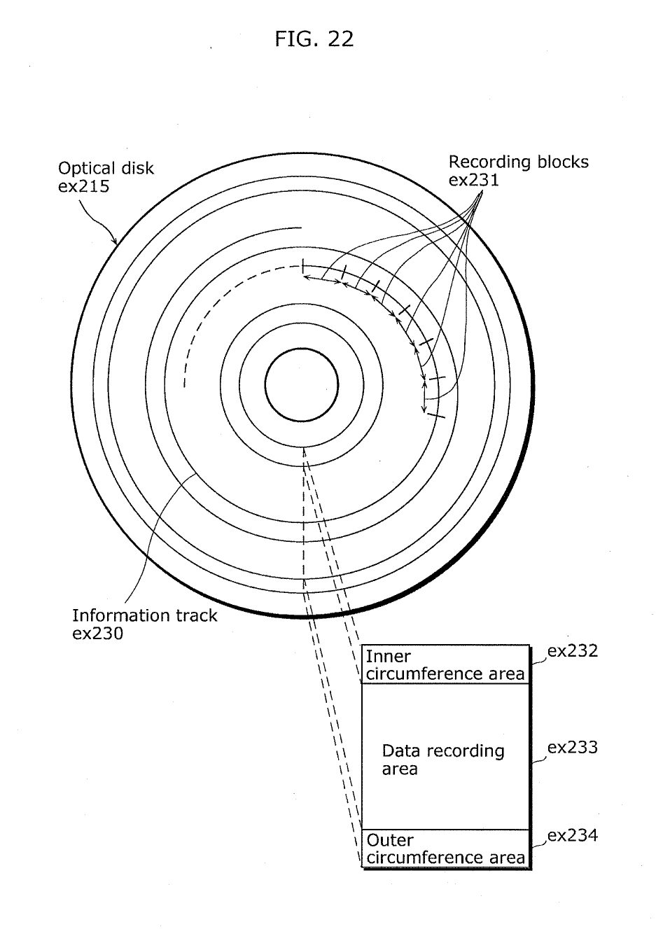

FIG. 22 schematically illustrates the recording medium ex215 that is the optical disc. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. An apparatus that records and reproduces data reproduces the information track ex230 and reads the address information so as to determine the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit ex400 reads and writes coded audio data, coded, video data, or coded data obtained by multiplexing the coded audio data and the coded video data, from and on the data recording area ex233 of the recording medium ex215.

Although an optical disc having a layer, such as a DVD and a BD is described as an example in the description, the optical disc is not limited to such, and may be an optical disc having a multilayer structure and capable of being recorded on a part other than the surface. Furthermore, the optical disc may have a structure for multidimensional recording/reproduction, such as recording of information using light of colors with different wavelengths in the same portion of the optical disc and recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be the one for example, including a GPS receiving unit in the configuration illustrated in FIG. 20. The same will be true for the configuration of the computer ex111, the cellular phone ex114, and others.

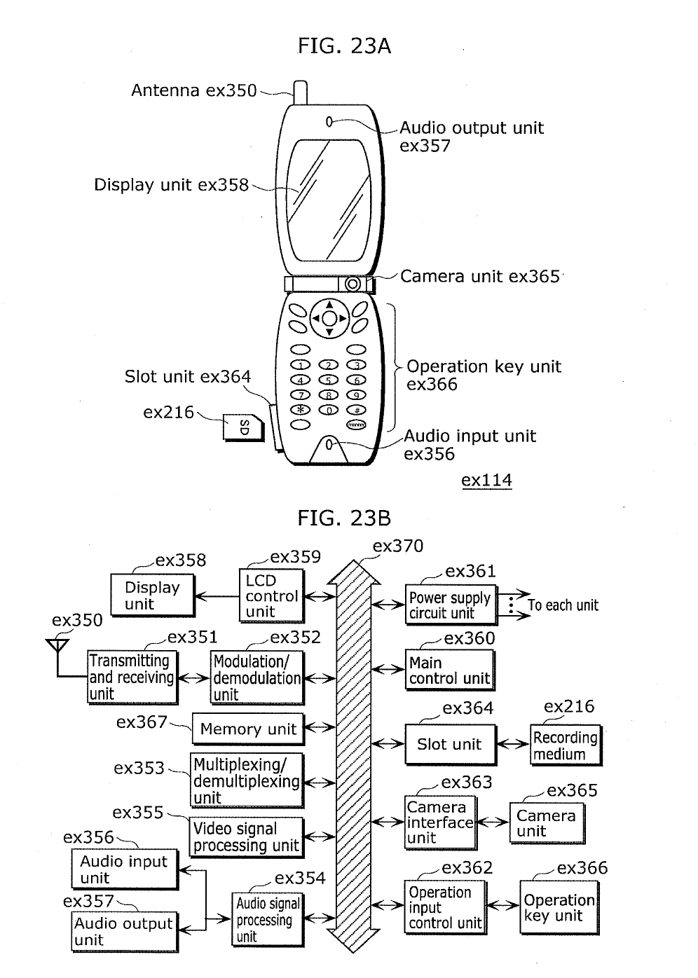

FIG. 23A illustrates the cellular phone ex114 that uses the moving picture coding method and the moving picture decoding method described in Embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including a set of operation keys ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 23B. In the cellular phone ex114, a main control unit ex360 designed to control overall each unit of the main body including the display unit ex358 as well as the operation keys ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key and a power key are turned ON by a user's operation, the power supply circuit unit ex360 supplies the respective units with power from a battery pack so as to activate the cell phone ex114 that is digital and is equipped with the camera.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex356.

Furthermore, when an e-mail in data communication mode is transmitted, text data of the e-mail inputted by operating the operation keys ex366 and others of the main body is sent out to the main control unit ex360 via the operation input control unit ex362. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the moving picture coding method shown in each of Embodiments (that is, functioning as the image coding apparatus according to the present invention), and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation unit (modulation/demodulation circuit unit) ex352 performs spread spectrum processing on the digital audio signals, and the transmitting and receiving unit ex351 performs digital-to-analog conversion and frequency conversion on the data, so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bitstream and an audio data bitstream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the moving picture coding method shown in each of Embodiments (that is, functioning as the image decoding apparatus according to the present invention), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 may have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in each of Embodiments can be used in any of the devices and systems described. Thus, the advantages described in each of Embodiments can be obtained.

Furthermore, the present invention is not limited to Embodiments, and various modifications and revisions are possible without departing from the scope of the present invention.

### Embodiment 4

Video data can be generated by switching, as necessary, between (i) the moving picture coding method or the moving picture coding apparatus shown in each of Embodiments and (ii) a moving picture coding method or a moving picture coding apparatus in conformity with a different standard, such as MPEG-2, MPEG-4 AVC, and VC-1.

Here, when a plurality of video data that conforms to the different standards is generated and is then decoded, the decoding methods need to be selected to conform to the different standards. However, since to which standard each of the plurality of the video data to be decoded conforms cannot be identified, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in each of Embodiments will be hereinafter described. The multiplexed data is a digital stream in the MPEG2-Transport Stream format.

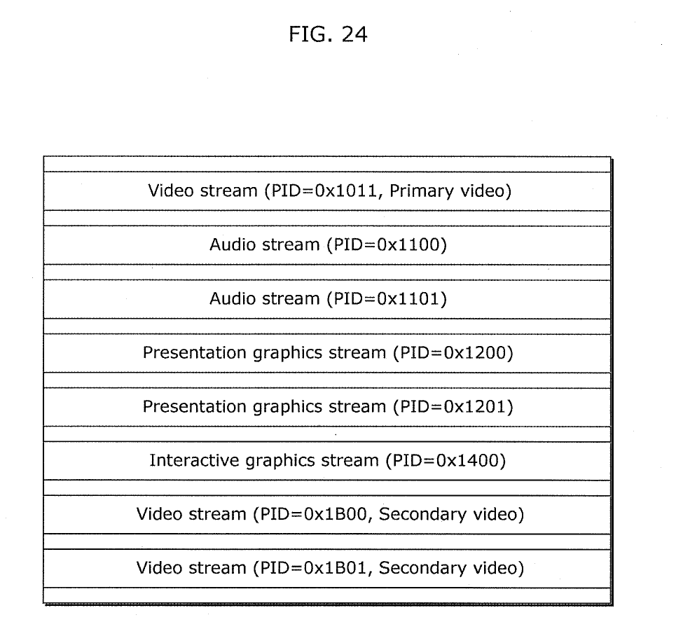

FIG. 24 illustrates a structure of the multiplexed data. As illustrated in FIG. 24, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of a movie. Here, the primary video is normal video to be displayed on a screen, and the secondary video is video to be displayed on a smaller window in the main video. Furthermore, the interactive graphics stream represents an interactive screen to be generated by arranging the GUI components on a screen. The video stream is coded in the moving picture coding method or by the moving picture coding apparatus shown in each of Embodiments, or in a moving picture coding method or by a moving picture coding apparatus in conformity with a conventional standard, such as MPEG-2, MPEG-4 AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary video to be mixed with the primary audio.

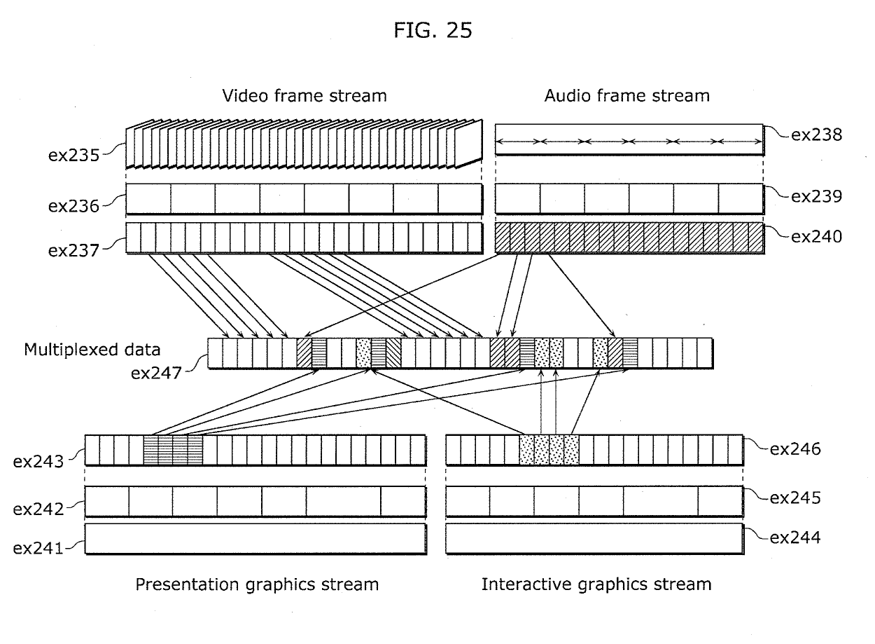

FIG. 25 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

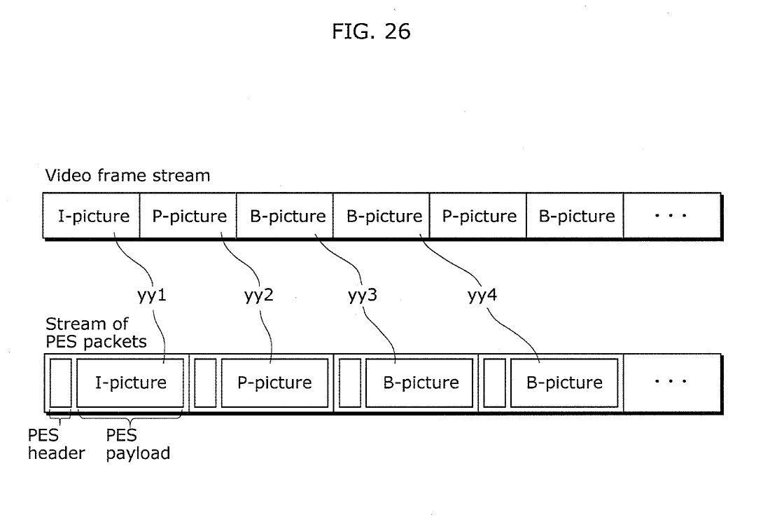

FIG. 26 illustrates how a video stream is stored in a stream of PES packets in more detail. The first bar in FIG. 26 shows a video frame stream in a video stream. The second bar shows the stream of PES packets. As indicated by arrows denoted as yy2, yy2, yy3, and yy4 in FIG. 26, the video stream is divided into pictures as I-pictures, B-pictures, and P-pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

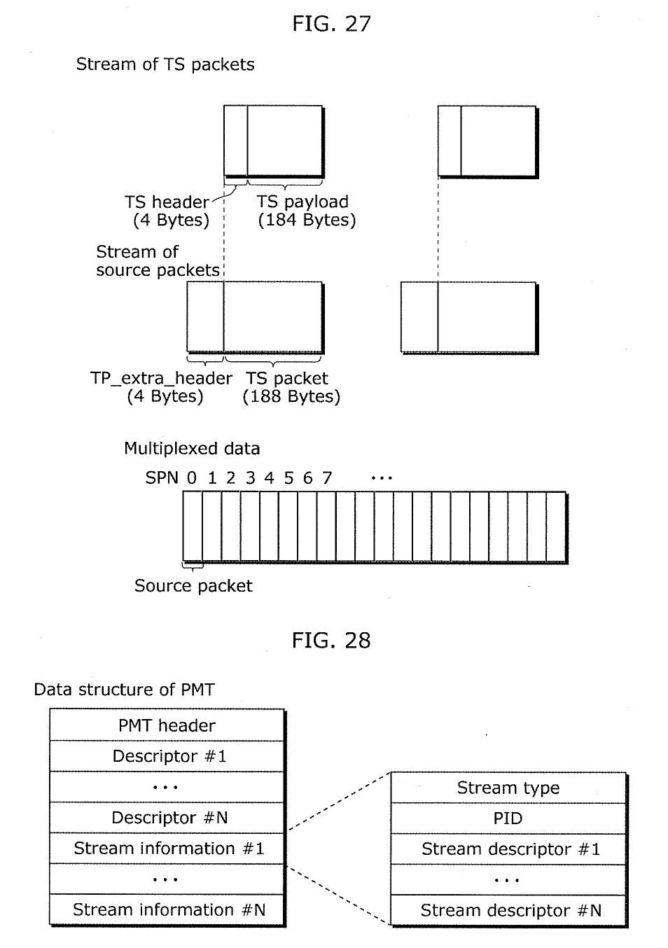

FIG. 27 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 27. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

FIG. 28 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

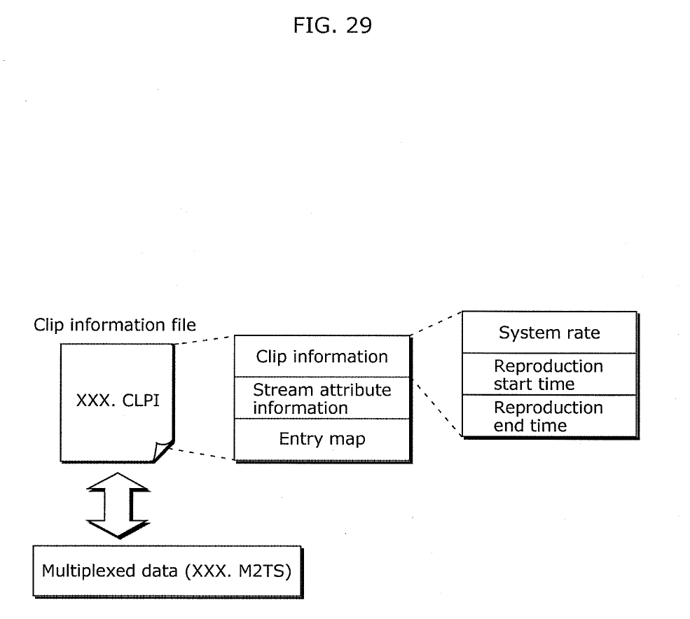

Each of the multiplexed data information files is management information of the multiplexed data as shown in FIG. 29. The multiplexed data information files are in one to one correspondence with the multiplexed data, and each of the files includes multiplexed data information, stream attribute information, and an entry map.

As illustrated in FIG. 29, the multiplexed data includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

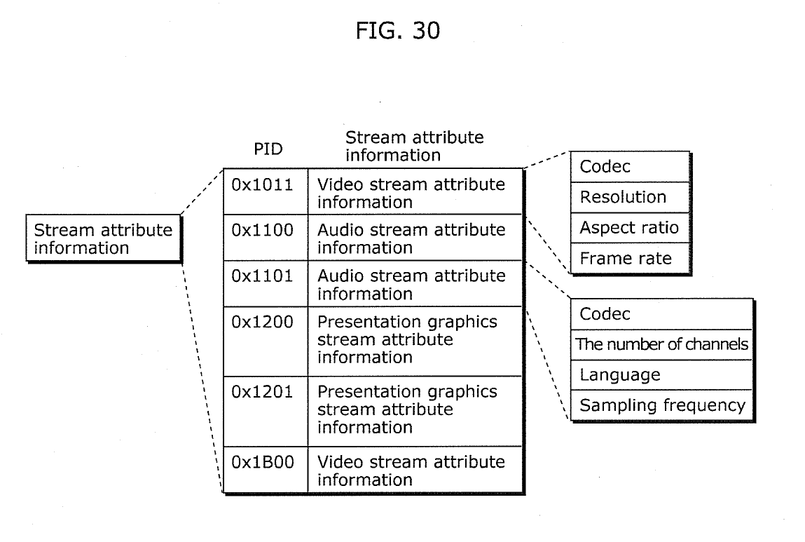

As shown in FIG. 30, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In Embodiment 4, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in each of Embodiments includes a step or a unit for allocating unique information indicating video data generated by the moving picture coding method or the moving picture coding apparatus in each of Embodiments, to the stream type included in the PMT or the video stream attribute information. With the configuration, the video data generated by the moving picture coding method or the moving picture coding apparatus described in each of Embodiments can be distinguished from video data that conforms to another standard.

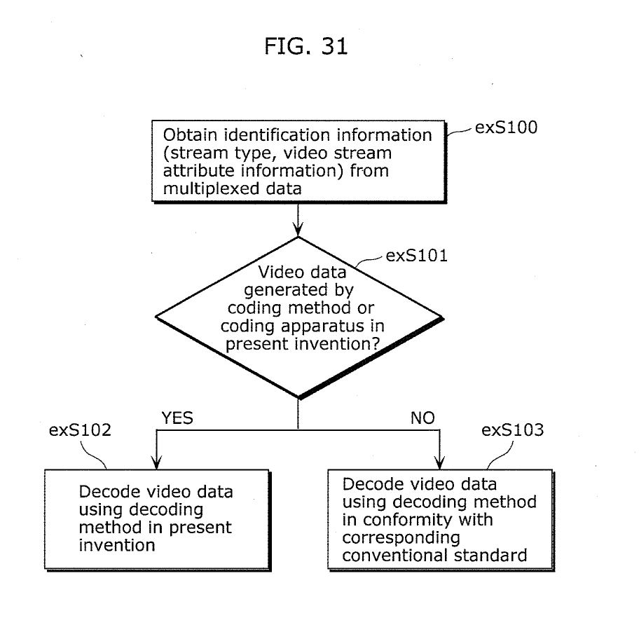

Furthermore, FIG. 31 illustrates steps of the moving picture decoding method according to Embodiment 4. In Step exS100, the stream type included in the PMT or the video stream attribute information is obtained from the multiplexed data. Next, in Step exS101, it is determined whether or not the stream type or the video stream attribute information indicates that the multiplexed data is generated by the moving picture coding method or the moving picture coding apparatus in each of Embodiments. When it is determined that the stream type or the video stream attribute information indicates that the multiplexed data is generated by the moving picture coding method or the moving picture coding apparatus in each of Embodiments, in Step exS102, the stream type or the video stream attribute information is decoded by the moving picture decoding method in each of Embodiments. Furthermore, when the stream type or the video stream attribute information indicates conformance to the conventional standards, such as MPEG-2, MPEG-4 AVC, and VC-1, in Step exS103, the stream type or the video stream attribute information is decoded by a moving picture decoding method in conformity with the conventional standards.

As such, allocating a new unique value to the stream type or the video stream attribute information enables determination whether or not the moving picture decoding method or the moving picture decoding apparatus that is described in each of Embodiments can perform decoding. Even upon an input of multiplexed data that conforms to a different standard, an appropriate decoding method or apparatus can be selected. Thus, it becomes possible to decode information without any error. Furthermore, the moving picture coding method or apparatus, or the moving picture decoding method or apparatus in Embodiment 4 can be used in the devices and systems described above.

### Embodiment 5

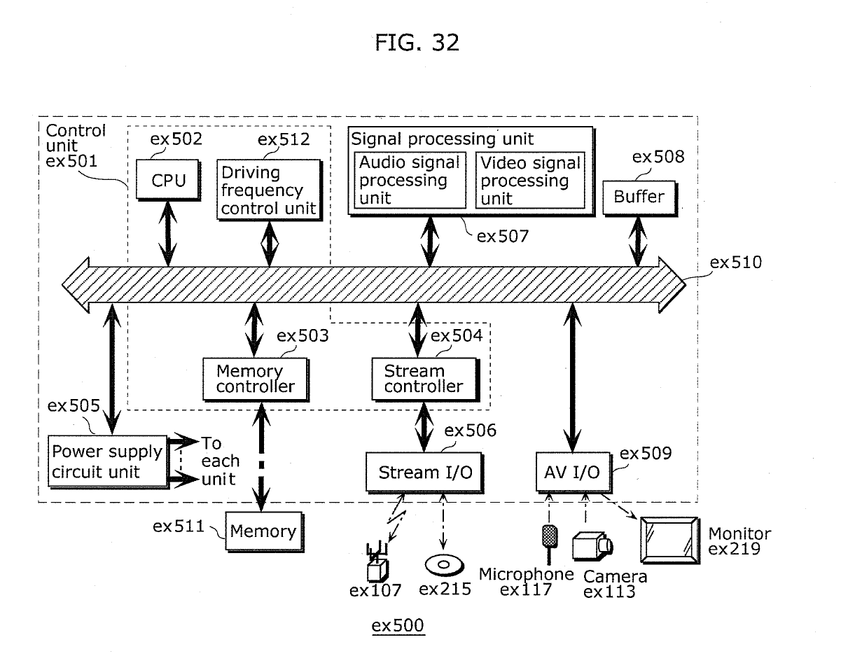

Each of the moving picture coding method, the moving picture coding apparatus, the moving picture decoding method, and the moving picture decoding apparatus in each of Embodiments is typically achieved in the form of an integrated circuit or a Large Scale Integrated (LSI) circuit. As an example of the LSI, FIG. 32 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the computing amount and speed to be transmitted to a signal processing unit ex507. Then, the signal processing unit ex507 codes an audio signal and/or a video signal. Here, the coding of the video signal is the coding described in each of Embodiments. Furthermore, the signal processing unit ex507 sometimes multiplexes the coded audio data and the coded video data, and a stream IO ex506 provides the multiplexed data outside. The provided multiplexed data is transmitted to the base station ex107, or written on the recording media ex215. When data sets are multiplexed, the data sets should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present invention is applied to biotechnology.

### Embodiment 6

When video data is decoded in the moving picture coding method or by the moving picture coding apparatus described in each of Embodiments, compared to when video data that conforms to a conventional standard, such as MPEG-2, MPEG-4 AVC, and VC-1, the computing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

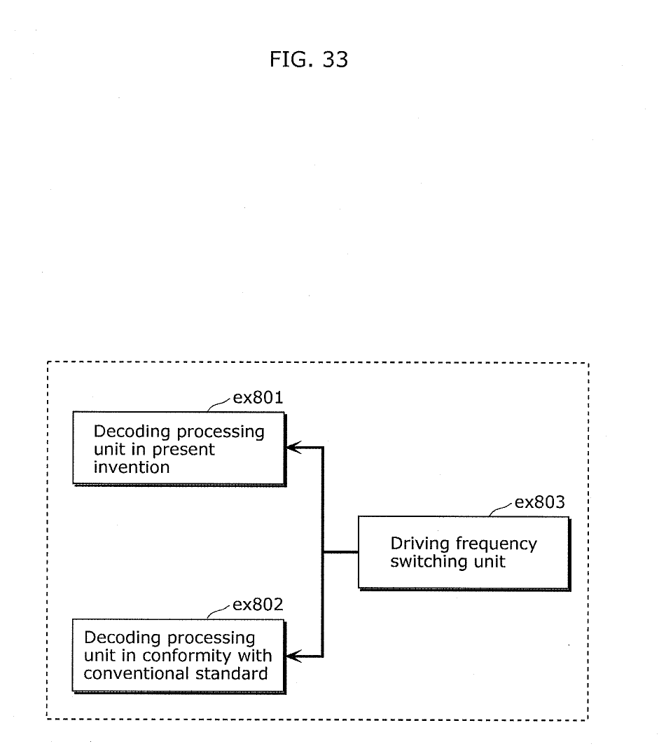

In order to solve the problem, the moving picture decoding apparatus, such as the television ex300 and the LSI ex500 is configured to determine to which standard the video data conforms, and switch between the driving frequencies according to the determined standard. FIG. 33 illustrates a configuration ex800 in Embodiment 6. A driving frequency switching unit ex803 sets a driving frequency to a higher driving frequency when video data is generated by the moving picture coding method or the moving picture coding apparatus described in each of Embodiments. Then, the driving frequency switching unit ex803 instructs a decoding processing unit ex801 that executes the moving picture decoding method described in each of Embodiments to decode the video data. When the video data conforms to the conventional standard, the driving frequency switching unit ex803 sets a driving frequency to a lower driving frequency than that of the video data generated by the moving picture coding method or the moving picture coding apparatus described in each of Embodiments. Then, the driving frequency switching unit ex803 instructs the decoding processing unit ex802 that conforms to the conventional standard to decode the video data.

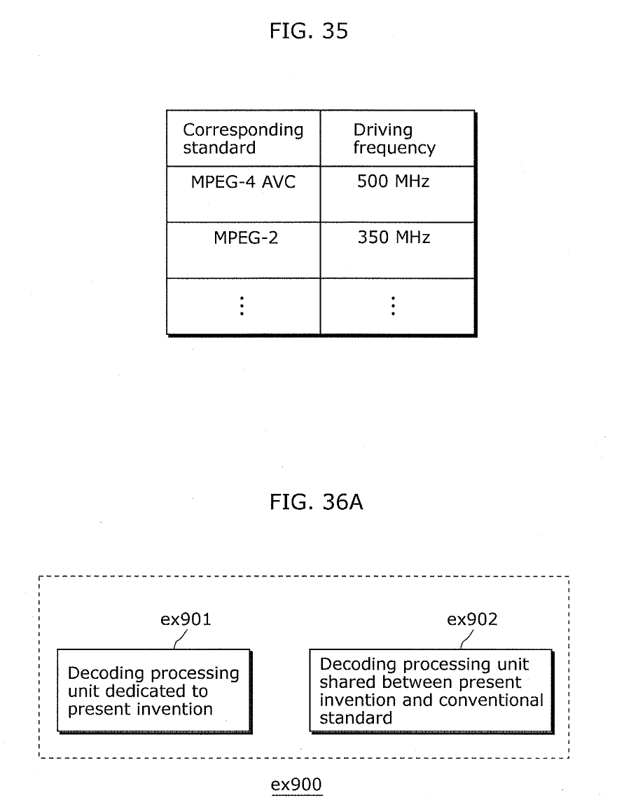

More specifically, the driving frequency switching unit ex803 includes the CPU ex502 and the driving frequency control unit ex512 in FIG. 32. Here, each of the decoding processing unit ex802 that executes the moving picture decoding method described in each of Embodiments and the decoding processing unit ex802 that conforms to the conventional standard corresponds to the signal processing unit ex507 in FIG. 32. The CPU ex502 determines to which standard the video data conforms. Then, the driving frequency control unit ex512 determines a driving frequency based on a signal from the CPU ex502. Furthermore, the signal processing unit ex507 decodes the video data based on a signal from the CPU ex502. For example, the identification information described in Embodiment 6 is probably used for identifying the video data. The identification information is not limited to the one described in Embodiment 6 but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 35. The driving frequency can be selected by storing the look-up table in the buffer ex508 and an internal memory of an LSI and with reference to the look-up table by the CPU ex502.

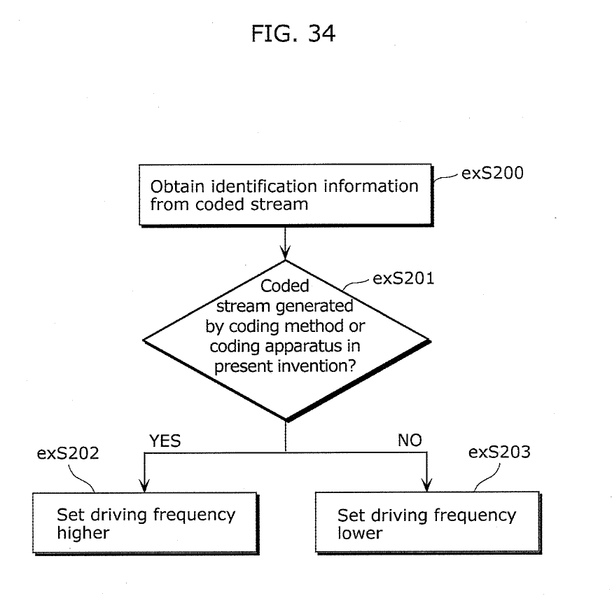

FIG. 34 illustrates steps for executing a method in Embodiment 6. First, in Step exS200, the signal processing unit ex507 obtains identification information from the multiplexed data. Next, in Step exS201, the CPU ex502 determines whether or not the video data is generated based on the identification information by the coding method and the coding apparatus described in each of Embodiments. When the video data is generated by the coding method and the coding apparatus described in each of Embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG-4 AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the coding method and the coding apparatus described in each of Embodiments.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the computing amount for decoding is larger, the driving frequency may be set higher, and when the computing amount for decoding is smaller, the driving frequency may be set lower as the method for setting the driving frequency. Thus, the setting method is not limited to the ones described above. For example, when the computing amount for decoding video data in conformity with MPEG-4 AVC is larger than the computing amount for decoding video data generated by the moving picture coding method and the moving picture coding apparatus described in each of Embodiments, the driving frequency is probably set in reverse order to the setting described above.

Furthermore, the method for setting the driving frequency is not limited to the method for setting the driving frequency lower. For example, when the identification information indicates that the video data is generated by the moving picture coding method and the moving picture coding apparatus described in each of Embodiments, the voltage to be applied to the LSI ex500 or the apparatus including the LSI ex500 is probably set higher. When the identification information indicates that the video data conforms to the conventional standard, such as MPEG-2, MPEG-4 AVC, and VC-1, the voltage to be applied to the LSI ex500 or the apparatus including the LSI ex500 is probably set lower. As another example, when the identification information indicates that the video data is generated by the moving picture coding method and the moving picture coding apparatus described in each of Embodiments, the driving of the CPU ex502 does not probably have to be suspended. When the identification information indicates that the video data conforms to the conventional standard, such as MPEG-2, MPEG-4 AVC, and VC-1, the driving of the CPU ex502 is probably suspended at a given time because the CPU ex502 has extra processing capacity. Even when the identification information indicates that the video data is generated by the moving picture coding method and the moving picture coding apparatus described in each of Embodiments, in the case where the CPU ex502 may have a time delay, the driving of the CPU ex502 is probably suspended at a given time. In such a case, the suspending time is probably set shorter than that in the case where when the identification information indicates that the video data conforms to the conventional standard, such as MPEG-2, MPEG-4 AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### Embodiment 7

There are cases where a plurality of video data that conforms to a different standard, is provided to the devices and systems, such as a television and a mobile phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

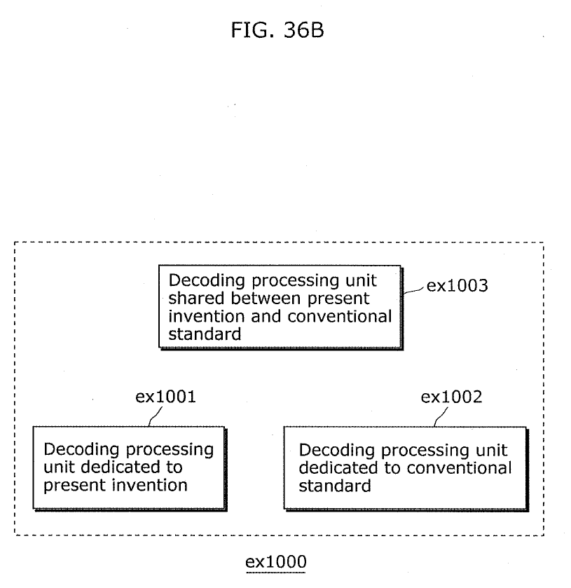

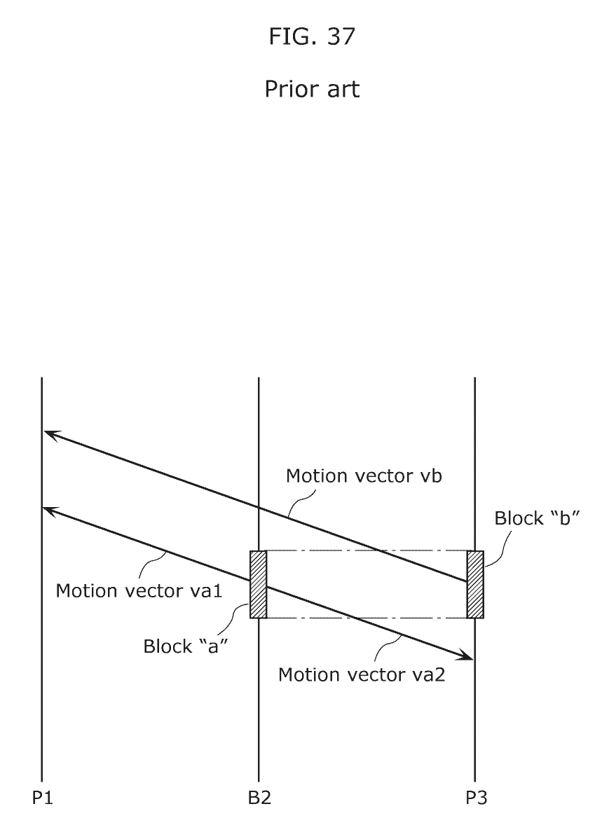

In order to solve the problem, what is conceived is a configuration in which the decoding processing unit for implementing the moving picture decoding method described in each of Embodiments and the decoding processing unit that conforms to the conventional standard, such as MPEG-2, MPEG-4 AVC, and VC-1 are partly shared. Ex900 in FIG. 36A shows an example of the configuration. For example, the moving picture decoding method described in each of Embodiments and the moving picture decoding method that conforms to MPEG-4 AVC have, partly in common, the details of processing, such as entropy coding, inverse quantization, deblocking filtering, and motion compensated prediction. The details of processing to be shared probably include use of a decoding processing unit ex902 that conforms to MPEG-4 AVC. In contrast, a dedicated decoding processing unit ex901 is probably used for other processing unique to the present invention. Since the present invention is characterized by motion compensation in particular, for example, the dedicated decoding processing unit ex901 is used for the motion compensation. Otherwise, the decoding processing unit is probably shared for one of the entropy coding, deblocking filtering, and inverse quantization, or all of the processing. The decoding processing unit for implementing the moving picture decoding method described in each of Embodiments may be shared for the processing to be shared, and a dedicated decoding processing unit may be used for processing unique to that of MPEG-4 AVC.

Furthermore, ex1000 in FIG. 36B shows another example in that processing is partly shared. This example uses a configuration including a dedicated decoding processing unit ex1001 that supports the processing unique to the present invention, a dedicated decoding processing unit ex1002 that supports the processing unique to another conventional standard, and a decoding processing unit ex1003 that supports processing to be shared between the moving picture decoding method in the present invention and the conventional moving picture decoding method. Here, the dedicated decoding processing units ex1001 and ex1002 are not necessarily specialized for the processing of the present invention and the processing of the conventional standard, respectively, and may be the ones capable of implementing general processing. Furthermore, the configuration of Embodiment 7 can be implemented by the LSI ex500.

As such, reducing the scale of the circuit of an LSI and reducing the cost are possible by sharing the decoding processing unit for the processing to be shared between the moving picture decoding method in the present invention and the moving picture decoding method in conformity with the conventional standard.

### INDUSTRIAL APPLICABILITY

The image coding method and the image decoding method according to the present invention are applicable to, for example, televisions, digital video recorders, car navigation systems, mobile phones, digital cameras, or digital video cameras.

### REFERENCE SIGNS LIST

101 Subtracting unit
102 Orthogonal transform unit
103 Quantization unit
104 Variable length coding unit
105, 205 Inverse quantization unit
106, 206 Inverse orthogonal transform unit
107, 207 Adding unit
108, 208 Block memory
109, 209 Frame memory
110, 210 Intra prediction unit
111, 211 Inter prediction unit
112, 212 Switch unit
113 Picture type determining unit
114, 214 Inter prediction control unit
115 Co-located information determining unit
116, 216 Temporal motion vector predictor calculating unit
117, 217 ColPic memory
118 ColPic information reading unit
119 ColPic information writing unit
204 Variable length decoding unit

1. An image coding method for coding an image, the method comprising:
writing, to a memory, a first motion vector for a first sub-block included in a first block in a first picture;
reading, from the memory, the first motion vector written to the memory;
coding a second motion vector for a second sub-block included in a second block, using the first motion vector read from the memory, the second block being a block in a second picture different from the first picture and being located in a position corresponding to a position of the first block;
selecting a representative motion vector from among motion vectors for sub-blocks included in the first block;
determining whether or not the representative motion vector is used in place of the first motion vector; and
adding, to a bitstream, a flag indicating whether or not the representative motion vector is used,
wherein when the representative motion vector is used:
in the writing, the representative motion vector is written to the memory in place of the first motion vector;
in the reading, the representative motion vector is read from the memory in place of the first motion vector; and
in the coding, the second motion vector is coded using the representative motion vector in place of the first motion vector.

2. The image coding method according to claim 1, further comprising
scaling the representative motion vector, using a display order of a reference picture to be referenced by the representative motion vector and a display order of a reference picture to be referenced by the first motion vector,
wherein when the representative motion vector is used, in the coding, the second motion vector is coded using the scaled representative motion vector.

3. The image coding method according to claim 1,
wherein in the selecting of a representative motion vector, one of the motion vectors that is to be used in bi-directional prediction is preferentially selected, as the representative motion vector.

4. The image coding method according to claim 1,
wherein in the selecting of a representative motion vector, the representative motion vector is selected from among the motion vectors for the sub-blocks to which inter prediction is to be applied.

5. The image coding method according to claim 1,
wherein in the selecting of a representative, motion vector, the representative, motion vector is selected by searching, the motion vectors for the representative motion vector in a predetermined order.

6. The image coding method according to claim 5,
wherein the predetermined order is one of a raster order and a zigzag scan order, from an upper left position to a lower right position in the first block, end
in the selecting of a representative, motion vector, the representative motion vector is selected by searching for the representative motion vector in one of the Taster order and the zigzag scan order.

7. The image coding method according to claim 5,
wherein the predetermined order is an order from a periphery to a center of the first block, and
in the selecting of a representative motion vector, the representative motion vector is selected by searching for the representative motion vector in the order from the periphery to the center of the first block.

8. The image coding method according to claim 1,
wherein in the selecting of a representative motion vector, when a representative sub-block that is a sub-block having the representative motion vector has two or more motion vectors, the two or more motion vectors are selected as a plurality of the representative motion vectors,
the image coding method further comprises selecting one of the two or more motion vectors, based on whether or not the first picture precedes or follows the second picture in display order, and
when the representative motion vector is used, in the coding, the second motion vector is coded using the selected one of two or more motion vectors.

9. The image coding method according to claim 8,
wherein in the selecting of one of the two or more motion vectors:
when (i) the two or more motion vectors include a motion vector that references a picture that precedes the first picture and a motion vector that references a picture that follows the first picture and (ii) the first picture precedes the second picture, the motion vector that references the picture that precedes the first picture is selected from among, the two or more motion vectors; and
when (i) the two or more motion vectors include the motion vector that references the picture that precedes the first picture and the motion vector that references the picture that follows the first picture and (ii) the first picture follows the second picture, the motion vector that references the picture that follows the first picture is selected from among, the two or more motion vectors.

10. The image coding method according to claim 8,
wherein in the selecting of one of the two or more motion vectors:
when (i) one of the two or more motion vectors references a picture that precedes the first picture and (ii) an other one of the two or more motion vectors references a picture that follows the first picture, one of the two or more motion vectors is selected based on whether the first picture precedes or follows the second picture in display order, and
when all of the two or more motion vectors reference a picture that precedes the first picture or reference a picture that follows the first picture, one of the two or more motion vectors is selected irrespective of whether the first picture precedes or follows the second picture in display order.

11. An image decoding method for decoding an image, the method comprising:
writing, to a memory, a first motion vector for a first sub-block included in a first block in a first picture;
reading, from the memory, the first motion vector written to the memory;
decoding a second motion vector for a second sub-block included in a second block, using, the first motion vector read from the memory, the second block being a block in a second picture different from the first picture and being located in a position corresponding to a position of the first block;
selecting a representative motion vector from among motion vectors for sub-blocks included in the first block; and
obtaining a flag indicating whether or not the representative motion vector is used, from a bitstream,
wherein when the representative motion vector is used:
in the writing, the representative motion vector is written to the memory in place of the first motion vector;
in the reading, the representative motion vector is read from the memory in place of the first motion vector; and
in the decoding, the second motion vector is decoded using the representative motion vector in place of the first motion vector.

12. The image decoding method according to claim 11, further comprising
scaling the representative motion vector, using a display order of a reference picture to be referenced by the representative motion vector and a display order of a reference picture to be referenced by the first motion vector,
wherein when the representative motion vector is used, in the decoding, the second motion vector is decoded using the scaled representative motion vector.

13. The image decoding method according to claim 11,
wherein in the selecting of a representative motion vector, one of the motion vectors that is to be used in bi-directional prediction is preferentially selected as the representative motion vector.

14. The moving picture decoding method according to claim 11,
wherein in the selecting of a representative motion vector, the representative motion vector is selected from among the motion vectors for the sub-blocks to which inter prediction is to be applied.

15. The moving picture decoding method according to claim 11,
wherein in the selecting of a representative motion vector, the representative motion vector is selected by searching the motion vectors for the representative motion vector in a predetermined order.

16. The image decoding method according to claim 15,
wherein the predetermined order is one of a raster order and a zigzag scan order, from an upper left position to a lower right position in the first block, and
in the selecting of a representative motion vector, the representative motion vector is selected by searching for the representative motion vector in one of the raster order and the zigzag scan order.

17. The image decoding method according to claim 15,
wherein the predetermined order is an order from a periphery to a center of the first block, and
in the selecting of a representative motion vector, the representative motion vector is selected by searching for the representative motion vector in the order from the periphery to the center of the first block.

18. The moving picture decoding method according to claim 11,
wherein in the selecting of a representative motion vector, when a representative sub-block that is a sub-block having the representative motion vector has two or more motion vectors, the two or more motion vectors are selected as a plurality of the representative motion vectors,
the image decoding method further comprises selecting one of the two or more motion vectors, based on whether or not the first picture precedes or follows the second picture in display order, and
when the representative motion vector is used, in the decoding, the second motion vector is decoded using the selected one of two or more motion vectors.

19. The image decoding method according to claim 18,
wherein in the selecting of one of the two or more motion vectors:
when (i) the two or more motion vectors include a motion vector that references a picture that precedes the first picture and a motion vector that references a picture that follows the first picture and (ii) the first picture precedes the second picture, the motion vector that references the picture that precedes the first picture is selected from among the two or more motion vectors; and
when (i) the two or more motion vectors include the motion vector that references the picture that precedes the first picture and the motion vector that references the picture that follows the first picture and (ii) the first picture follows the second picture, the motion vector t references the picture that follows the first picture is selected from among the two or more motion vectors.

20. The image decoding method according to claim 18,
wherein in the selecting of one of the two or more motion vectors:
when (i) one of the two or more motion vectors references a picture that precedes the first picture and (ii) an other one of the two or more motion vectors references a picture that follows the first picture, one of the two or more motion vectors is selected based on whether the first picture precedes or follows the second picture in display order, and
when all of the two or more motion vectors reference a picture that precedes the first picture or reference a picture that follows the first picture, one of the two or more motion vectors is selected irrespective of whether the first picture precedes or follows the second picture in display order.
